(19) United States
(12) Patent Application Publication
(10) Pub. No.: US 2006/0031870 A1
(43) Pub. Date: Feb. 9, 2006

(54) Apparatus, system, and method for filtering objectionable portions of a multimedia presentation

(76) Inventors: Matthew T. Jarman, Salt Lake City, UT (US); Jason Seeley, Bountiful, UT (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/104,924

(22) Filed: Apr. 12, 2005

Related U.S. Application Data
(63) Continuation-in-part of application No. 09/694,873, filed on Oct. 23, 2000, now Pat. No. 6,898,799.
(63) Continuation-in-part of application No. 09/695,102, filed on Oct. 23, 2000, now Pat. No. 6,889,383.
(60) Provisional application No. 60/561,851, filed on Apr. 12, 2004.

(51) Int. Cl. H04N 7/16

(52) U.S. Cl. 725/25

(57) ABSTRACT

A method for filtering portions of a multimedia presentation. A stream of multimedia media data read from a memory media is compared with a filter file associated with the multimedia data. The filter file includes a start position, a stop position, and a filtering action to perform on the portion of the multimedia content that begins at the start position and ends at the stop position. When the multimedia data read from the media corresponds with the filter file, the designated filtering action is performed. Aspects of the invention also pertain to the format for the filter file, format for accessing filter files on a memory media.

### CROSS-REFERENCE TO RELATED APPLICATIONS

The present application is a non-provisional application claiming priority to U.S. provisional application 60/561,851 titled “Apparatus, System, and Method for Filtering Objectionable Portions of an Audio Visual Presentation”, filed on Apr. 12, 2004. The present application also claims priority to and is a continuation-in-part of U.S. application Ser. No. 09/694,873 titled “Multimedia Content Navigation and Playback” filed on Oct. 23, 2000, and claims priority to and is a continuation-in-part of U.S. application Ser. No. 09/695,102 titled “Delivery of Navigation Data for Playback of Audio and Video Content” filed on Oct. 23, 2000, the disclosure of each of the above-recited priority applications are hereby incorporated by reference herein.

### FIELD OF THE INVENTION

Aspects of the present invention involve a system, method, apparatus and file formats related to filtering portions of a multimedia presentation.

### BACKGROUND

Often, movies and other multimedia presentations contain scenes or language that are unsuitable for viewers of some ages. To help consumers determine whether a particular movie is appropriate for an audience of a given age, the Motion Picture Association of America (“MPAA”) has developed the now familiar NC-17/R/PG-13/PG/G rating system. Other organizations have developed similar rating systems for other types of multimedia content, such as television programming, computer software, video games, and music.

Both the quantity and context of potentially objectionable material are significant factors in assigning a multimedia presentation a rating. However, a relatively small amount of mature-focused subject matter may be sufficient to remove multimedia content from a rating category recommended for younger children. For example, in a motion picture setting, a single scene of particularly explicit violence, sexuality, or language may require an “R” rating for what would otherwise be a “PG” or “PG-13” movie. As a result, even if an “R” rated motion picture has a general public appeal, individuals trying to avoid “R” rated content, and teenagers restricted by the “R” rating, may choose not to view a motion picture that they would otherwise desire to view if it were not for the inclusion of the explicit scene.

Many consumers may prefer an alternate version of the multimedia presentation, such as a version that has been modified to make the content more suitable for all ages. To provide modified versions of multimedia works, the prior art has focused on manipulating the multimedia source. The details of how multimedia content is modified depends largely on the type of access the source media supports. For linear access media, such as videotape or audiotape, undesired content is edited from the tape and the remaining ends are spliced back together. The process is repeated for each portion of undesired content the multimedia source contains. Due to the need for specialized tools and expertise, it is impractical for individual consumers to perform this type of editing. While third parties could perform this editing to modify content on a consumer's behalf, the process is highly inefficient because it requires physically handling and repeating the editing for each individual tape.

Modifying direct access media, such as DVD, also has focused on modifying the multimedia source. Unlike linear media, direct access media allows for accessing any arbitrary portion of the multimedia content in roughly the same amount of time as any other arbitrary portion of the multimedia content. Direct access media allows for the creation and distribution of multiple versions of multimedia content, including versions that may be suitable to most ages, and storing the versions on a single medium. The decoding process creates various continuous multimedia streams by identifying, selecting, retrieving and transmitting content segments from a number of available segments stored on the content source.

To help in explaining the prior art for creating multiple versions of a multimedia work on a single source, a high-level description of the basic components found in a system for presenting multimedia content may be useful. Typically, such systems include a multimedia source, a decoder, and an output device. The decoder is a translator between the format used to store or transmit the multimedia content and the format used for intermediate processing and ultimately presenting the multimedia content at the output device. For example, multimedia content may be encrypted to prevent piracy and compressed to conserve storage space or bandwidth. Prior to presentation, the multimedia content must be decrypted and/or uncompressed, operations usually performed by the decoder.

The prior art teaches creation and distribution of multiple versions of a direct access multimedia work on a single storage medium by breaking the multimedia content into various segments and including alternate interchangeable segments where appropriate. Each individually accessible segment is rated and labeled based on the content it contains, considering such factors as subject matter, context, and explicitness. One or more indexes of the segments are created for presenting each of the multiple versions of the multimedia content. For example, one index may reference segments that would be considered a “PG” version of the multimedia whereas another index may reference segments that would be considered an “R” version of the content. Alternatively, the segments themselves or a single index may include a rating that is compared to a rating selected by a user.

There are a variety of benefits to the prior art's indexing of interchangeable segments to provide for multiple versions of a multimedia work on a single storage medium. Use of storage space can be optimized because segments common to the multiple versions need only be stored once. Consumers may be given the option of setting their own level of tolerance for specific subject matter and the different multimedia versions may contain alternate segments with varying levels of explicitness. The inclusion of segment indexing on the content source also enables the seamless playback of selected segments (i.e., without gaps and pauses) when used in conjunction with a buffer. Seamless playback is achieved by providing the segment index on the content source, thus governing the selection and ordering of the interchangeable segments prior to the data entering the buffer.

The use of a buffer compensates for latency that may be experienced in reading from different physical areas of direct access media. While read mechanisms are moved from one disc location to another, no reading of the requested content from the direct access media occurs. This is a problem because, as a general rule, the playback rate for multimedia content exceeds the access rate by a fairly significant margin. For example, a playback rate of 30 frames per second is common for multimedia content. Therefore, a random access must take less than 1/30th of a second (approximately 33 milliseconds) or the random access will result in a pause during playback while the reading mechanism moves to the next start point. A 16x DVD drive for a personal computer, however, has an average access rate of approximately 95 milliseconds, nearly three times the 33 milliseconds allowed for seamless playback. Moreover, according to a standard of the National Television Standards Committee (“NTSC”), only 5 to 6 milliseconds are allowed between painting the last pixel of one frame and painting the first pixel of the next frame. Those of skill in the art will recognize that the above calculations are exemplary of the time constraints involved in reading multimedia content from direct access media for output to a PC or television, even though no time is allotted to decoding the multimedia content after it has been read, time that would need to be added to the access time for more precise latency calculations.

Once access occurs, DVD drives are capable of reading multimedia content from a DVD at a rate that exceeds the playback rate. To address access latency, the DVD specification teaches reading multimedia content into a track buffer. The track buffer size and amount of multimedia content that must be read into the track buffer depend on several factors, including the factors described above, such as access time, decoding time, playback rate, etc. When stored on a DVD, a segment index, as taught in the prior art, with corresponding navigation commands, identifies and orders the content segments to be read into the track buffer, enabling seamless playback of multiple version of the multimedia content. However, segment indexes that are external to the content source are unable to completely control the navigation commands within the initial segment identification/selection/retrieval process since external indexes can interact with position codes only available at the end of the decoding process. As a result, external segment indexes may be unable to use the DVD track buffer in addressing access latency as taught in the prior art.

As an alternative to buffering, segments from separate versions of multimedia content may be interlaced. This allows for essentially sequential reading of the media, with unwanted segments being read and discarded or skipped. The skips, however, represent relatively small movements of the read mechanism. Generally, small movements involve a much shorter access time than large movements and therefore introduce only minimal latency.

Nevertheless, the prior art for including multiple versions of a multimedia work on a single direct access media suffers from several practical limitations that prevent it from wide-spread use. One significant problem is that content producers must be willing to create and broadly distribute multiple versions of the multimedia work and accommodate any additional production efforts in organizing and labeling the content segments, including interchangeable segments, for use with the segment indexes or maps. The indexes, in combination with the corresponding segments, define a work and are stored directly on the source media at the time the media is produced. In short, while the prior art offers a tool for authoring multiple versions of a multimedia work, that tool is not useful in and of itself to consumers.

A further problem in the prior art is that existing encoding technologies must be licensed in order to integrate segment indexes on a direct access storage medium and decoding technologies must be licensed to create a decoder that uses the segment indexes on a multimedia work to seamlessly playback multiple versions stored on the direct access medium. In the case of DVD, the Motion Pictures Entertainment Group (“MPEG”) controls the compression technology for encoding and decoding multimedia files. Furthermore, because producers of multimedia content generally want to prevent unauthorized copies of their multimedia work, they also employ copy protection technologies. The most common copy protection technologies for DVD media are controlled by the DVD Copy Control Association (“DVD CCA”), which controls the licensing of their Content Scramble System technology (“CSS”). Decoder developers license the relevant MPEG and CSS technology under fairly strict agreements that dictate how the technology may be used. In short, the time and cost associated with licensing existing compression and copy protection technologies or developing proprietary compression and copy protection technologies may be significant costs, prohibitive to the wide-spread use of the prior art's segment indexing for providing multiple versions of a multimedia work on a single direct access storage medium.

Additionally, the teachings of the prior art do not provide a solution for filtering direct access multimedia content that has already been duplicated and distributed without regard to presenting the content in a manner that is more suitable for most ages. At the time of filing this patent application, over 40,000 multimedia titles have been released on DVD without using the multiple version technology of the prior art to provide customers the ability to view and hear alternate versions of the content in a manner that is more suitable for most ages.

The prior art also has taught that audio portions of multimedia content may be identified and filtered during the decoding process by examining the closed caption information for the audio stream and muting the volume during segments of the stream that contain words matching with a predetermined set of words that are considered unsuitable for most ages. This art is limited in its application since it cannot identify and filter video segments and since it can only function with audio streams that contain closed captioning information. Furthermore, filtering audio content based on closed captioning information is imprecise due to poor synchronization between closed captioning information and the corresponding audio content.

### SUMMARY OF THE INVENTION

Aspects of the invention involve a method of filtering portions of a multimedia content presentation, the method comprising accessing at least one filter file defining a filter start indicator and a filter action; reading digital multimedia information from a memory media, the multimedia information including a location reference; comparing the location reference of the multimedia information with the filter start indicator; and responsive to the comparing operation, executing a filtering action if there is match between the location reference of the multimedia information and the filter start indicator of the at least one filterable portion of the multimedia content.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is high-level block diagram showing the basic components of a system embodying the present invention;

FIGS. 3A, 3B, and 3C, are block diagrams of three systems that provide greater detail for the basic components shown in FIG. 2;

FIGS. 4A, 5A, and 7, are flowcharts depicting exemplary methods for filtering multimedia content according to the present invention;

FIGS. 4B and 5B illustrate navigation objects in relation to mocked-up position codes for multimedia content;

FIG. 6 is a flowchart portraying a method used in customizing the filtering of multimedia content;

FIGS. 8A and 8B are flowcharts illustrating a method conforming to aspects of the present invention;

FIG. 9 is a representative block diagram of a menu arrangement conforming to aspects of the present invention;

FIGS. 10A-10C are representative block diagrams illustrating a filter processing action conforming to aspects of the present invention;

FIG. 11 is a representative block diagram of a menu arrangement conforming to aspects of the present invention;

FIG. 12 is a diagram illustrating aspects of a skip type filtering action conforming to aspects of the present invention;

FIG. 13 is a file format diagram for a skip type filtering action;

FIG. 14 is a diagram illustrating aspects of a mute type filtering action conforming to aspects of the present invention;

FIG. 15 is a file format diagram for a skip type filtering action; and

FIGS. 16-23 are file formats for indexing and filter table identification packets, conforming to aspects of the present invention.

### DETAILED DESCRIPTION OF EMBODIMENTS OF THE INVENTION

The present invention extends to methods, systems, and computer program products for automatically identifying and filtering portions of multimedia content during the decoding process. The embodiments of the present invention may comprise a special purpose or general purpose computer including various computer hardware, a television system, an audio system, and/or combinations of the foregoing. These embodiments are discussed in greater detail below. However, in all cases, the described embodiments should be viewed a exemplary of the present invention rather than as limiting it's scope.

Embodiments within the scope of the present invention also include computer-readable media for carrying or having computer-executable instructions or data structures stored thereon. Such computer-readable media may be any available media that can be accessed by a general purpose or special purpose computer. By way of example, and not limitation, such computer-readable media can comprise RAM, ROM, EEPROM, DVD, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications link or connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

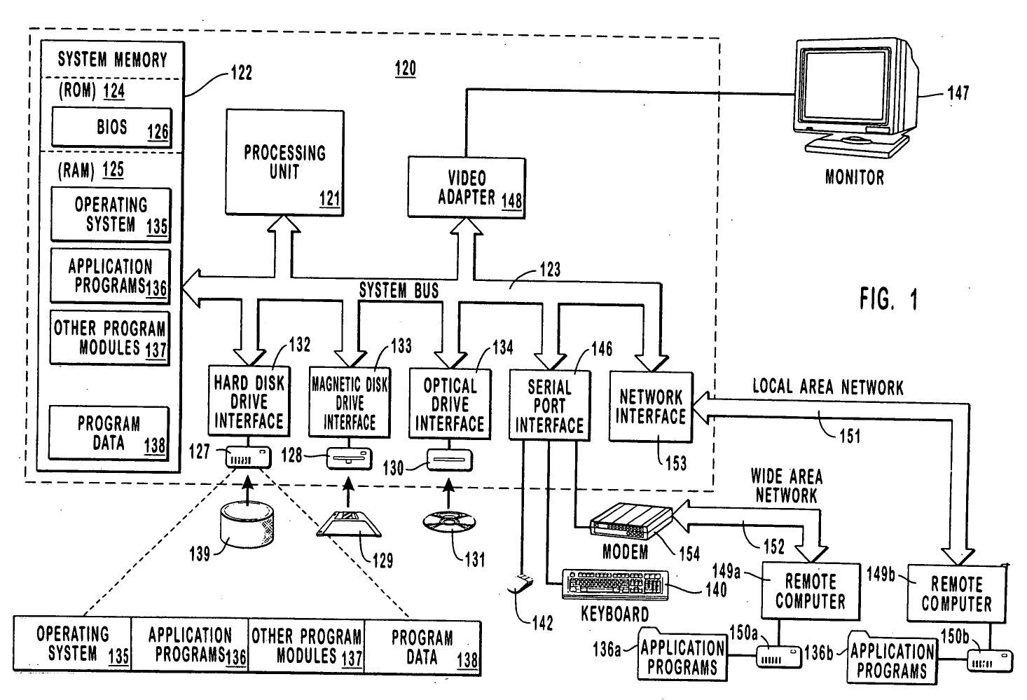

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps. Furthermore, program code means being executed by a processing unit provides one example of a processor means.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

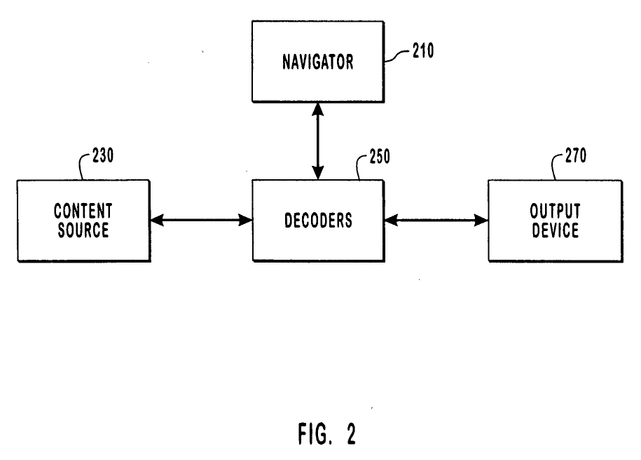

Turning next to FIG. 2, a high-level block diagram identifying the basic components of a system for filtering multimedia content are shown. The basic components include content source 230, decoders 250, navigator 210, and output device 270. Content source 230 provides multimedia to decoder 250 for decoding, navigator 210 controls decoder 250 so that filtered content does not reach output device 270, and output device 270 plays the multimedia content it receives. As used in this application, the term “multimedia” should be interpreted broadly to include audio content, video content, or both.

The present invention does not require a particular content source 230. Any data source that is capable of providing multimedia content, such as a DVD, a CD, a memory, a hard disk, a removable disk, a tape cartridge, and virtually all other types of magnetic or optical media may operate as content source 230. Those of skill in the art will recognize that the above media includes read-only, read/write, and write-once varieties, whether stored in an analog or digital format. All necessary hardware and software for accessing these media types are also part of content source 230. Content source 230 as described above provides an example of multimedia source means.

Multimedia source 230 generally provides encoded content. Encoding represents a difference in the formats that are typically used for storing or transmitting multimedia content and the formats used for intermediate processing of the multimedia content. Decoders 250 translate between the storage and intermediate formats. For example, stored MPEG content is both compressed and encrypted. Prior to being played at an output device, the stored MPEG content is decrypted and uncompressed by decoders 250. Decoders 250 may comprise hardware, software, or some combination of hardware and software. Due to the large amount of data involved in playing multimedia content, decoders 250 frequently have some mechanism for transferring data directly to output device 270. Decoders 250 are an exemplary embodiment of decoder means.

Output device 270 provides an example of output means for playing multimedia content and should be interpreted to include any device that is capable of playing multimedia content so that the content may be perceived. For a computer system, like the one described with reference to FIG. 1, output device 270 may include a video card, a video display, an audio card, and speakers. Alternatively, output device 270 may be a television or audio system. Television systems and audio systems cover a wide range of equipment. A simple audio system may comprise little more than an amplifier and speakers. Likewise, a simple television system may be a conventional television that includes one or more speakers and a television screen. More sophisticated television and audio systems may include audio and video receivers that perform sophisticated processing of audio and video content to improve sound and picture quality.

Output device 270 may comprise combinations of computer, television, and audio systems. For example, home theaters represent a combination audio and television systems. These systems typically include multiple content sources, such as components for videotape, audiotape, DVD, CD, cable and satellite connections, etc. Audio and/or television systems also may be combined with computer systems. Therefore, output device 270 should be construed as including the foregoing audio, television, and computer systems operating either individually, or in some combination. Furthermore, when used in this application, computer system (whether for a consumer or operating as a server), television system, and audio system may identify a system's capabilities rather than its primary or ordinary use. These capabilities are not necessarily exclusive of one another. For example, a television playing music through its speakers is properly considered an audio system because it is capable of operating as an audio system. That the television ordinarily operates as part of a television system does not preclude it from operating as an audio system. As a result, terms like consumer system, server system, television system, and audio system, should be given their broadest possible interpretation to include any system capable of operating in the identified capacity.

Navigator 210 is software and/or hardware that control the decoders 250 by determining if the content being decoded needs to be filtered. Navigator 210 is one example of multimedia navigation means. It should be emphasized that content source 230, decoders 250, output device 270, and navigator 210 have been drawn separately only to aid in their description. Some embodiments may combine content source 230, decoders 250, and navigator 210 into a single set-top box for use with a television and/or audio system. Similarly, a computer system may combine portions of decoder 250 with output device 270 and portions of decoder 250 with content source 230. Many other embodiments are possible, and therefore, the present invention imposes no requirement that these four components must exist separately from each other. As such, the corresponding multimedia source means, decoder means, output means, and multimedia navigation means also need not exist separately from each other and may be combined together as is appropriate for a given embodiment of the present invention. It is also possible for content source 230, decoders 250, output device 270, and/or navigator 210 to be located remotely from each other and linked together with a communication link.

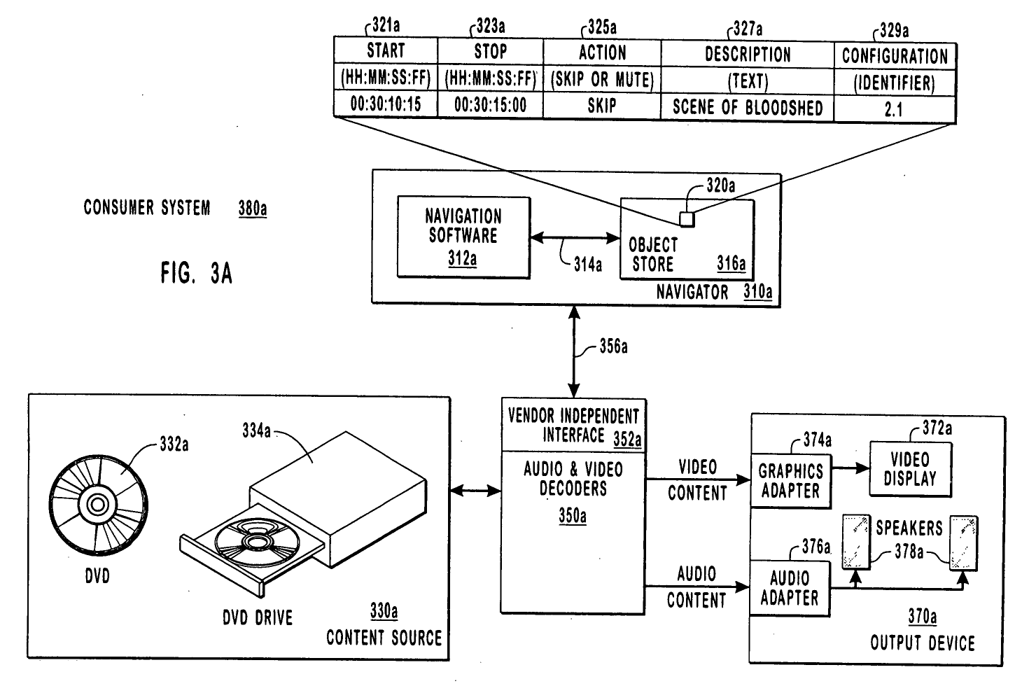

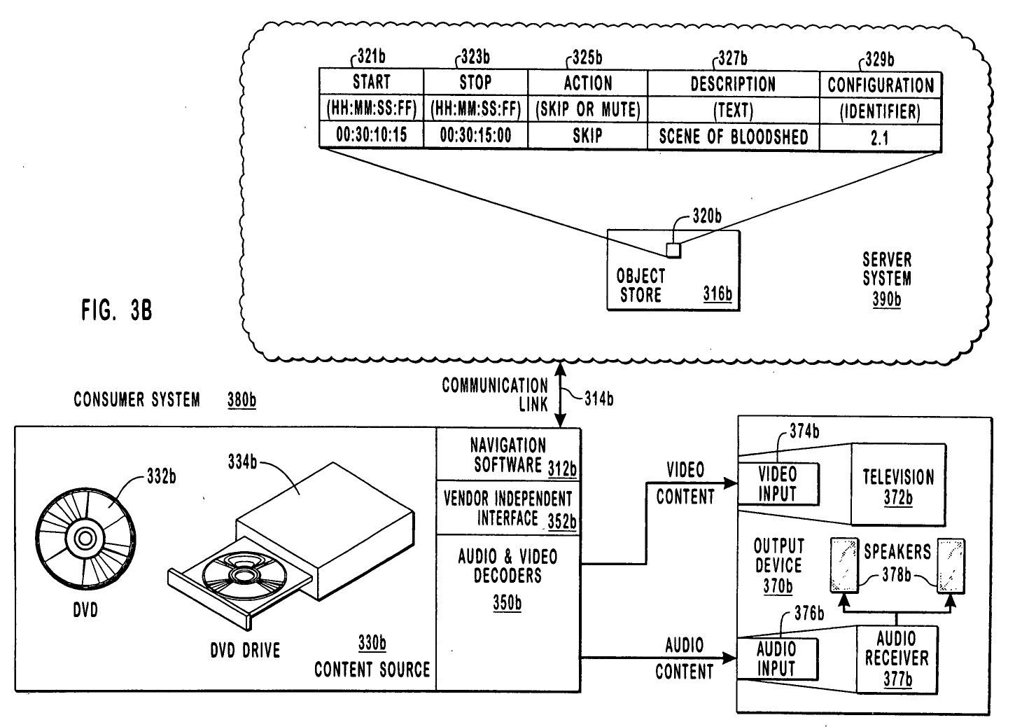

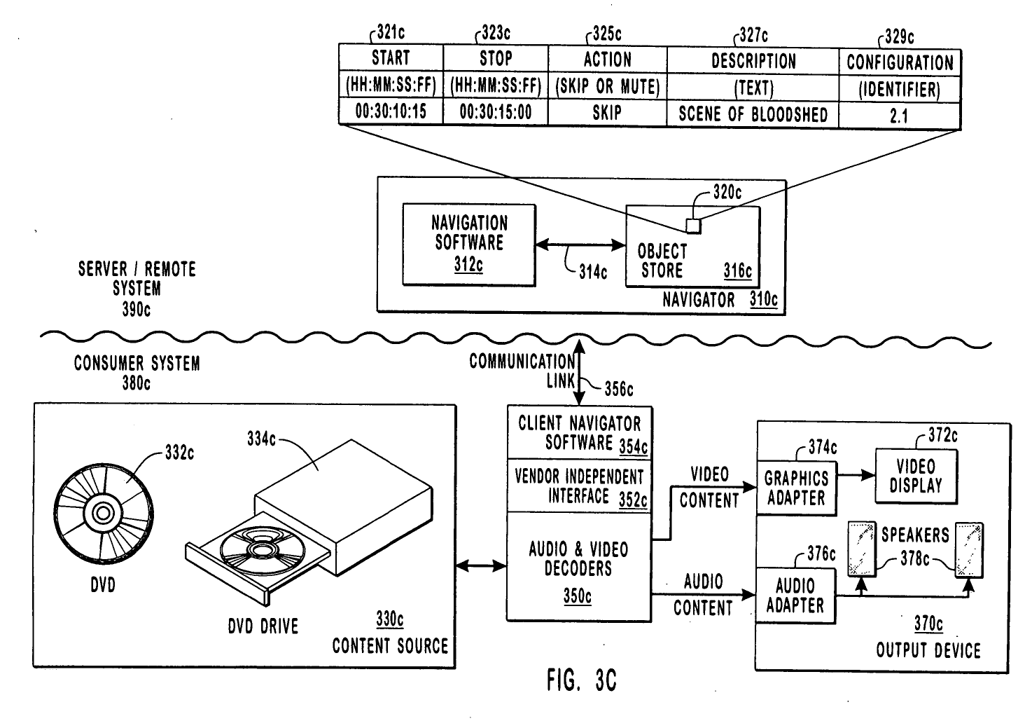

As noted previously, FIGS. 3A, 3B, and 3C, are block diagrams of three exemplary systems that provide greater detail for the basic components shown in FIG. 2. However, the present invention is not limited to any particular physical organization of the components shown in FIG. 2. Those of skill in the art will recognize that these basic components are subject to a wide-range of embodiments, including a single physical device or several physical devices. Therefore, FIG. 2 and all other figures should be viewed as exemplary of embodiments according to the present invention, rather than as restrictions on the present invention's scope.

Similar to FIG. 2, FIG. 3A includes navigator 310a, content source 330a, audio and video decoders 350a, and output device 370a, all located at consumer system 380a. Content source 330a includes DVD 332a and DVD drive 334a. The bi-directional arrow between content source 330a and audio and video decoders 350a indicates that content source 330 provides multimedia content to audio and video decoders 350a and that audio and video decoders 350a send commands to content source 330a when performing filtering operations.

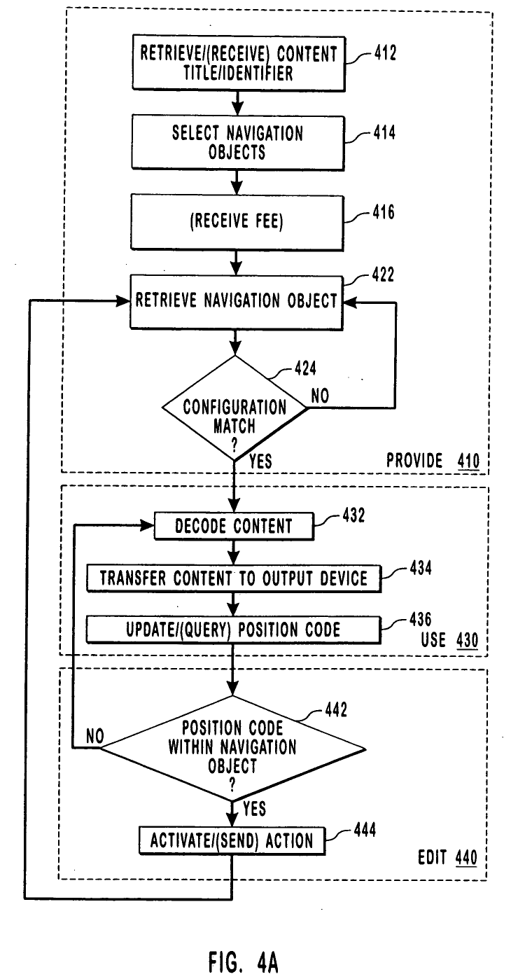

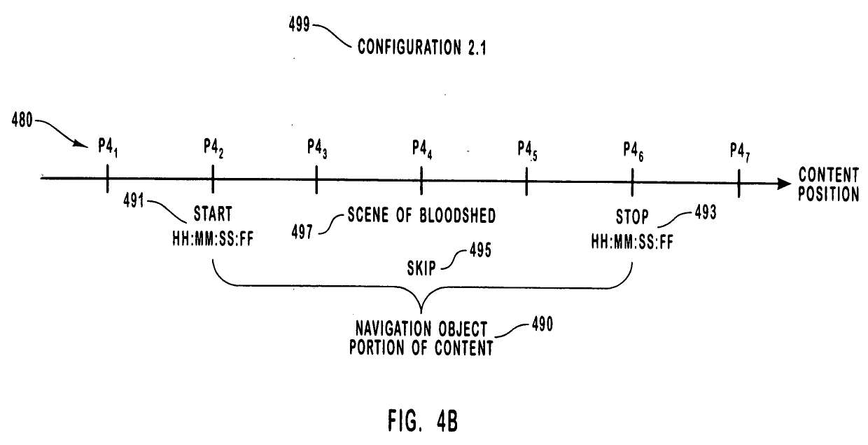

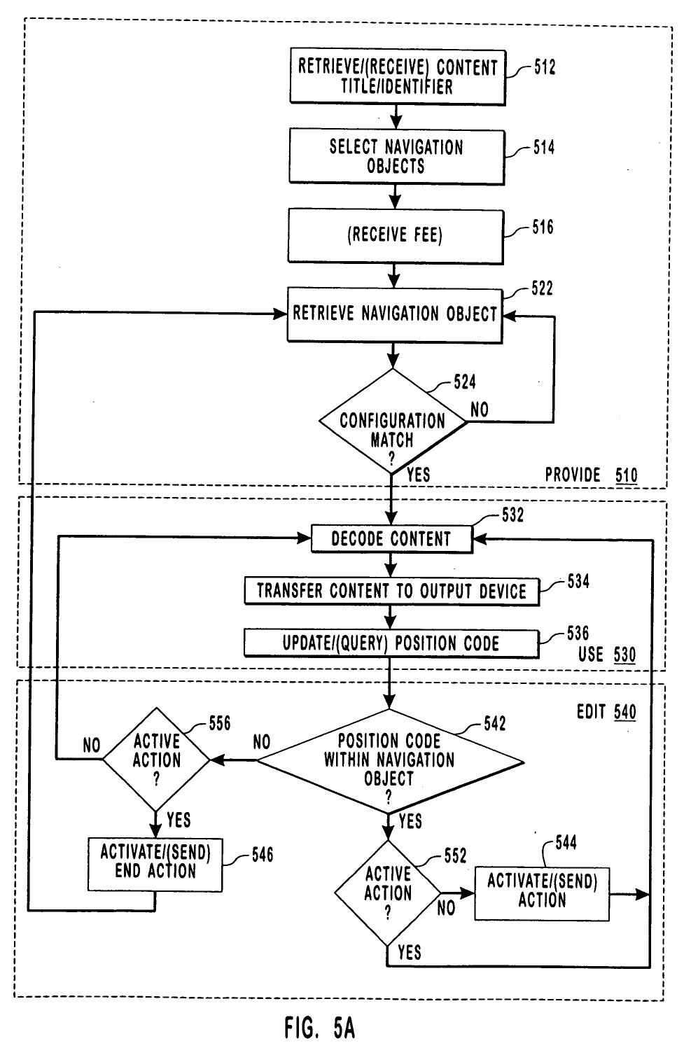

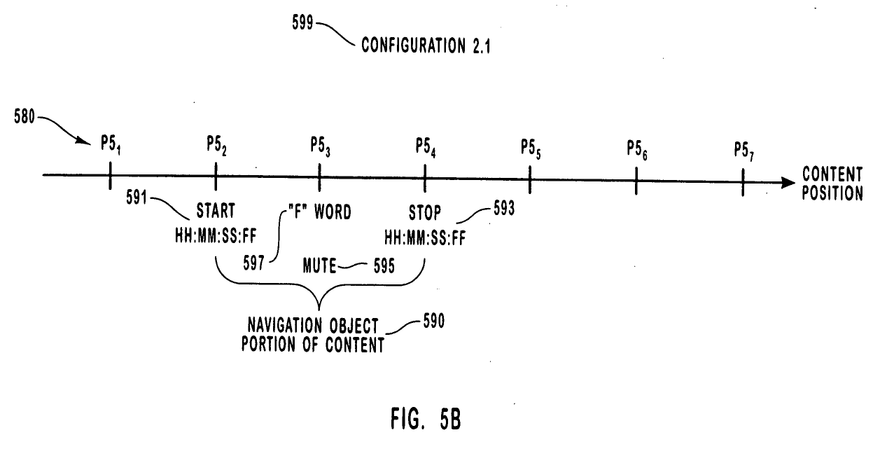

Navigator 310a monitors decoders 350a by continuously updating the time code of the multimedia content being decoded. (Time codes are an example of positions used in identifying portions of multimedia content. In the case of time codes, positioning is based on an elapsed playing time from the start of the content. For other applications, positions may relate to physical quantities, such as the length of tape moving from one spool to another in a videotape or audiotape. The present invention does not necessarily require any particular type of positioning for identifying portions of multimedia content.) In one embodiment, the time code updates occur every 1/10th of a second, but the present invention does not require any particular update interval. (The description of FIGS. 4B and 5B provides some insight regarding factors that should be considered in selecting an appropriate update interval.)

Communication between Navigator 310a and audio and video decoders 350a occurs through a vendor independent interface 352a. The vendor independent interface 352a allows navigator 310a to use the same commands for a number of different content sources. Microsoft's® DirectX® is a set of application programming interfaces that provides a vendor independent interface for content sources 330a in computer systems running a variety of Microsoft operating systems. Audio and video decoders 350a receive commands through vendor independent interface 352a and issue the proper commands for the specific content source 330a.

Audio and video decoders 350a provide audio content and video content to output device 370a. Output device 370a includes graphics adapter 374a, video display 372a, audio adaptor 376a, and speakers 378a. Video display 372a may be any device capable of displaying video content, regardless of format, including a computer display device, a television screen, etc.

Usually, graphics adaptors and audio adaptors provide some decoding technology so that the amount of data moving between content source 330a and output device 370a is minimized. Graphics adaptors and audio adaptors also provide additional processing for translating multimedia content from the intermediate processing format to a format more suitable for display and audio playback. For example, many graphics adaptors offer video acceleration technology to enhance display speeds by offloading processing tasks from other system components. In the case of graphics and audio adaptors, the actual transition between decoders 350a and output device 370a may be a somewhat fuzzy. To the extent graphics adaptor 374a and audio adapter 376a perform decoding, portions of those adaptors may be properly construed as part of decoders 350a.

Navigator 310a includes navigation software 312a and object store 316a. Bi-directional arrow 314a indicates the flow of data between navigation software 312a and object store 316a. Object store 316a contains a plurality of navigation objects 320a. Within object store 316a, navigation objects may be stored as individual files that are specific to particular multimedia content, they may be stored in one or more common databases, or some other data management system may be used. The present invention does not impose any limitation on how navigation objects are stored in object store 316a.

Each navigation object 320a defines when (start 321a and stop 323a) an filtering action (325a) should occur for a particular system (329a) and provides a description (327a) of why the navigation object was created. Start and stop positions (321a and 323a) are stored as time codes, in hours:minutes:seconds:frame format; actions may be either skip or mute (325a); the description is a text field (327a); and configuration is an identifier (329a) used to determine if navigation object 320a applies to a particular consumer system 380b. The values indicate that the start position 321a is 00:30:10:15; stop position 323a is 00:30:15:00; the filtering action 325a is skip; the description 327a is “scene of bloodshed” and the configuration 329a is 2.1. More detail regarding navigation objects, such as navigation object 320a, will be provided with reference to FIGS. 4B and 5B.

As navigator 310a monitors audio and video decoders 350a for the time code of the multimedia content currently being decoded, the time code is compared to the navigation objects in object store 316a. When the position code falls within the start and stop positions defined by a navigation object, navigator 310a activates the filtering action assigned to the navigation object. For navigation object 320a, a time code within the approximately four-second range of 00:30:10:15-00:30:15:00 result in navigator 310a issuing a command to audio and video decoders 350a to skip to the end of the range so that the multimedia content within the range is not decoded and is not given to output device 370a. The process of filtering multimedia content will be described in more detail with reference to FIGS. 4A, 5A, 6, and 7.

As in FIG. 3A, FIG. 3B includes a content source 330b, audio and video decoders 350b, and output device 370b. In FIG. 3B, however, object store 316b is located at server system 390b, and all other components are located at consumer system 380b. As shown by start 321b, stop 323b, action 325b, description 327b, and configuration 329b, the contents of navigation object 320b remain unchanged.

Content source 330b, including DVD drive 334b and DVD 332b, have been combined with audio and video decoders 350b, vendor independent interface 352b, and navigation software 312b into a single device. Communication between navigation software 312b and object store 316b occurs over communication link 314b. Communication link 314b is an example of communication means and should be interpreted to include any communication link for exchanging data between computerized systems. The particular communication protocols for implementing communication link 314b will vary from one embodiment to another. In FIG. 3B, at least a portion of communication link 314b may include the Internet.

Output device 370b includes a television 372b with video input 374b and an audio receiver 377b with an audio input 376b. Audio receiver 377b is connected to speakers 378b. As noted earlier, the sophistication and complexity of output device 370b depends on the implementation of a particular embodiment. As shown, output device 370b is relatively simple, but a variety of components, such as video and audio receivers, amplifiers, additional speakers, etc., may be added without departing from the present invention. Furthermore, it is not necessary that output device 370b include both video and audio components. If multimedia content includes only audio content, the video components are not needed. Likewise, if the multimedia content includes only video data, the audio components of output device 370b may be eliminated.

Moving next to FIG. 3C, navigator 310c, content source 330c, audio and video decoders 350c, and output device 370c are all present. Like FIG. 3B, FIG. 3C includes a server/remote system 390c and a consumer system 380c. For the embodiment shown in FIG. 3C, navigator 310C is located at server/remote system 390c and content source 330c, audio and video decoders 350c, and output device 370c are located at the consumer system 380c.

Navigator 310c includes server navigation software 312c and object store 316c, with data being exchanged as bi-directional arrow 314c indicates. Start 321c, stop 323c, action 325c, description 327c, and configuration 329c, show that the contents of navigation object 320c remain unchanged from navigation objects 320b and 320a (FIGS. 3B and 3A). Content source 330c includes DVD drive 334c and DVD 332c, and output device 370c includes graphics adaptor 374c, video display 372c, audio adapter 376c, and speakers 378c. Because content source 330c and output device 370c are identical to the corresponding elements in FIG. 3A, their descriptions will not be repeated here.

In contrast to FIG. 3A, client navigator software 354c had been added to audio and video decoders 350c and vendor independent interface 352c. Client navigator software 354c supports communication between navigation software 312c and vendor independent interface 352c through communication link 356c. In some embodiments, no client navigator software 354c will be necessary whereas in other embodiments, some type of communication interface supporting communication link 356c may be necessary. For example, suppose consumer system 380c is a personal computer, server/remote system 390c is a server computer, and at least a portion of communication link 356c includes the Internet. Client navigator software 354c may be helpful in establishing communication link 356c and in passing information between consumer system 380c and server/remote system 390c.

Now, suppose content source 330c and audio and video decoders 350c are combined as in a conventional DVD player. Server/remote system 390c may be embodied in a remote control unit that controls the operation of the DVD player over an infrared or other communication channel. Neither client navigator software 354c nor vendor independent interface 352c may be needed for this case because server/remote system 390c is capable of direct communication with the DVD player and the DVD player assumes responsibility for controlling audio and video decoders 350c.

Several exemplary methods of operation for the present invention will be described with reference to the flowcharts illustrated by FIGS. 4A, 5A, 6, and 7, in connection with the mocked-up position codes and navigation objects presented in FIGS. 4B and 5B. FIG. 4A shows a sample method for filtering multimedia content according to the present invention. Although FIGS. 4A, 5A, 6, and 7 show the method as a sequence of events, the present invention is not necessarily limited to any particular ordering. Because the methods may be practiced in both consumer and server systems, parentheses have been used to identify information that is usually specific to a server.

Beginning with a consumer system, such as the one shown in FIG. 3A, an object store may be part of a larger data storage. For example, a separate object store may exist for multimedia content stored on individual DVD titles. Because many object stores have been created, at block 412 the multimedia content title is retrieved from the content source. Alternatively, a single object store may contain navigation objects corresponding to more than one DVD title. At block 414, with the title identifier, the object store and corresponding navigation objects that are specific to a particular DVD title are selected. (Receive fee, block 416, will be described later, with reference to a server system.) At block 422, the first navigation object for the DVD title identified at 412 is retrieved.

Turning briefly to FIG. 4B, a navigation object is shown in the context of multimedia content. Content positions 480 identify various positions, labeled P41, P42, P43, P44, P45, P46, and P47, that are associated with the multimedia content. The navigation object portion 490 of the content begins at start 491 (P42) and ends at stop 493 (P46). Skip 495 is the filtering action assigned to the navigation object and scene of bloodshed 497 is a text description of the navigation object portion 490 of the multimedia content. Configuration 499 identifies the hardware and software configuration of a consumer system to which the navigation object applies. For example, configuration 499 may include the make, model, and software revisions for the consumer's computer, DVD drive, graphics card, sound card, and may further identify the DVD decoder and the consumer computer's motherboard.

The motivation behind configuration 499 is that different consumer systems may introduce variations in how navigation objects are processed. As those variations are identified, navigation objects may be customized for a particular consumer system without impacting other consumer systems. The configuration identifier may be generated according to any scheme for tracking versions of objects. In FIG. 4B, the configuration identifier includes a major and minor revision, separated by a period.

Returning now to FIG. 4A, a navigation object as described above has been retrieved at block 422. Decision block 424 determines whether the configuration identifier of the navigation object matches the configuration of the consumer system. Matching does not necessarily require exact equality between the configuration identifier and the consumer system. For example, if major and minor revisions are used, a match may only require equality of the major revision. Alternatively, the configuration identifier of a navigation object may match all consumer configurations. Configuration identifiers potentially may include expressions with wildcard characters for matching one or more characters, numeric operators for determining the matching conditions, and the like. If no match occurs, returning to block 422 retrieves the next navigation object.

Retrieving a content identifier (412), selecting navigation objects (414), retrieving a navigation object (422), and determining whether the configuration identifier matches the consumer system configuration (424) have been enclosed within a dashed line to indicate that they are all examples of acts that may occur within a step for providing an object store having navigation objects.

With a navigation object identified, the decoders begin decoding the multimedia content (432) received from the DVD. Once decoded, the content is transferred (434) to the output device where in can be played for a consumer. While decoding the multimedia content, the position code is updated continuously (436). The acts of decoding (432), transferring (434), and continuously updating the position code (436) have been enclosed in a dashed line to indicate that they are examples of acts that are included within a step for using a decoder to determine when multimedia content is within a navigation object (430).

A step for filtering multimedia content (440) includes the acts of comparing the updated position code to the navigation object identified in block 422 to determine if the updated position code lies within the navigation object and the act of activating an filtering action (444) when appropriate. If the updated position code is not within the navigation object, decoding continues at block 432. But if the updated position code is within the navigation object, the filtering action is activated (444). Following activation of the filtering action, the next navigation object is retrieved at block 422.

Using the navigation object illustrated in FIG. 4B, the method of FIG. 4A will be described in greater detail. The navigation object is retrieved in block 422 and passes the configuration match test of block 424. After the multimedia content is decoded at block 432 and transferred to the output device at block 434, the position code is updated at block 436. P41 corresponds to the updated position code. Because P41 is not within the start and stop positions (491 and 493), more multimedia content is decoded (432), transferred to the output device (434), and the position code is updated again (436).

The updated position code is now P42. P42 also marks the beginning of the navigation object portion 490 of the multimedia content defined by the start and stop positions (491 and 493) of the navigation object. The video filtering action, skip 495 is activated in block 444. Activating the video filtering action sends a command to the decoder to discontinue decoding immediately and resume decoding at stop position 493. The content shown between P42 and P46 is skipped. Following the skip, the next navigation object is retrieved at block 422 and the acts describe above are repeated.

Abruptly discontinuing and resuming the decoding may lead to noticeable artifacts that detract from the experience intended by the multimedia content. To diminish the potential for artifacts, filtering actions may be incrementally activated or separate incremental filtering action may be used. For example, a fade out (e.g., normal to blank display) filtering action may precede a skip filtering action and a fade in (e.g., blank to normal display) filtering action may follow a skip filtering action. Alternatively, the fading out and fading in may be included as part of the skip filtering acting itself, with the start and stop positions being adjusted accordingly. The length of fade out and fade in may be set explicitly or use an appropriately determined default value. Incremental filtering actions need not be limited to a specific amount of change, such as normal to blank display, but rather should be interpreted to include any given change, such as normal to one-half intensity, over some interval. Furthermore, incremental filtering actions may be used to adjust virtually any characteristic of multimedia content.

Where multimedia content includes visual information being presented to a viewer, it is possible that unsuitable material may be localized to only a certain physical area of the scene as it is presented. In these cases one or more navigation objects with reframe filtering actions may be appropriate. The entire scene need not be skipped because the viewing frame may be positioned to avoid showing the unsuitable material and the remaining content may be enlarged to provide a full-size display. By continually adjusting the framing and sizing of multimedia content during a scene, the unsuitable material is effectively cropped from view.

Each reframe navigation object is capable of performing a number of reframe/resize actions, including the ability to reframe and resize on a frame-by-frame basis. Therefore, the number of reframe navigation objects used in cropping a particular scene depends on a variety of factors, including how the scene changes with time. A single navigation object may be sufficient to filter a relatively static scene, whereas more dynamic scenes will likely require multiple navigation objects. For example, one navigation object may be adequate to reframe a scene showing an essentially static, full-body, view of a person with a severe leg wound to a scene that includes only the person's head and torso. However, for more dynamic scenes, such as a scene where the person with the severe leg wound is involved in a violent struggle or altercation with another person, multiple reframe navigation objects may be required for improved results.

Positions P41, P42, P43, P44, P45, P46, and P47 are separated by the update inter Those of skill in the art will recognize that a shorter update interval will allow for more precise filtering. For example, if start 491 were shortly after position P42, multimedia decoding and output would continue until position P43, showing nearly ¼ of the multimedia content that was to be filtered. With an update interval occurring ten times each second, only a minimal amount of multimedia content that should be filtered (e.g., less than 1/10th of a second) will be displayed at the output device. As has been implied by the description of configuration identifier 499, it is reasonable to expect some variability in consumer systems and the invention should not be interpreted as requiring exact precision in filtering multimedia content. Variations on the order of a few seconds may be tolerated and accounted for by expanding the portion of content defined by a navigation object, although the variations will reduce the quality of filtering as perceived by a consumer because scenes may be terminated prior to being completely displayed.

The differences enclosed in parentheses for server operation are relatively minor and those of skill in the art will recognize that a consumer and server may cooperate, each performing a portion of the processing that is needed. FIG. 3B provides an exemplary system where processing is shared between a server system and a consumer system. Nevertheless, the following will describe the processing as it would occur at a server system, similar to the one shown in FIG. 3C, but with only the output device located at the consumer system.

At block 412, the server receives the DVD title identifier so that the proper navigation objects can be selected in block 414. The server receives a fee from the consumer system, in block 416, for allowing the consumer system access to the navigation objects. The fee may be a subscription for a particular time period, a specific number of accesses, etc. The first navigation object for the DVD title identified at 412 is retrieved in block 422 and checked for a configuration match in block 424. Because the configuration match is checked at the server, the consumer system supplies its configuration information or identifier. As described above, receiving a content identifier (412), selecting navigation objects (414), receiving a fee (416), retrieving a navigation object (422), and determining whether the configuration identifier matches the consumer system configuration (424) have been enclosed within a dashed line to indicate that they are all examples of acts that may occur within a step for the server system providing an object store having navigation objects.

Decoding the multimedia content (432) may occur at either the consumer system or the server system. However, sending decoded multimedia from a server system to a consumer system requires substantial communication bandwidth. At block 434, the multimedia content is transferred to the output device. The server system then queries (436) the client system decoder to update the position code. Alternatively, if the decoding occurred at the server system, the position code may be updated (436) without making a request to the consumer system. The acts of decoding (432), transferring (434), and continuously updating or querying for the position code (436) have been enclosed in a dashed line to indicate that they are examples of acts that are included within a step for the server system using a decoder to determine when multimedia content is within a navigation object (430).

The server system performing a step for filtering multimedia content (440) includes the acts of (i) comparing the updated position code to the navigation object identified in block 422 to determine if the updated position code lies within the navigation object, and (ii) activating or sending an filtering action (444) at the proper time. Decoding continues at block 432 for updated position codes that are not within the navigation object. Otherwise, the filtering action is activated or sent (444) for updated position codes within the navigation object. Activating occurs when the decoder is located at the consumer system, but if the decoder is located at the consumer system, the filtering action must be sent to the consumer system for processing. The next navigation object is retrieved at block 422 following activation of the filtering action, and processing continues as described above. The analysis of FIG. 4B will not be repeated for a server system because the server operation is substantially identical to the description provided above for a consumer system.

FIG. 5A illustrates a sample method for filtering audio content, possibly included with video content, according to the present invention. The steps for providing 510 and using 530, including the acts shown in processing blocks 512, 514, 516, 522, 524, 532, 534, and 536 are virtually identical to the corresponding steps and acts described with reference to FIG. 4A. Therefore, the description of FIG. 5A begins with a step for filtering (540) multimedia content.

Decision block 542 determines if an updated or queried position code (536) is within the navigation object identified in blocks 522 and 524. If so, decision block 552 determines whether or not an filtering action is active. For portions of multimedia content within a navigation object where the filtering action is active or has been sent (in the case of server systems), decoding can continue at block 532. If the filtering action is not active or has not been sent, block 544 activates or sends the filtering action and then continues decoding at block 532.

If decision block 542 determines that the updated or queried position code (536) is not within the navigation object, decision block 556 determines whether or not an filtering action is active or has been sent. If no filtering action is active or has been sent, decoding continues at block 532. However, if an filtering action has been activated or sent and the updated position code is no longer within the navigation object, block 546 activates or sends and end action and continues by identifying the next navigation object in blocks 522 and 524.

In general, some filtering may be accomplished with one action, like the video action of FIG. 4B, while others require ongoing actions, like the audio action of FIG. 5B. The mocked-up position codes and audio navigation object shown in FIG. 5B help explain the differences between single action filtering of multimedia content and continuous or ongoing filtering of multimedia content. Content positions 580 identify various positions, labeled P51, P52, P53, P54, P55, P56, and P57, that are associated with the multimedia content. The navigation object portion 590 of the content begins at start 591 (P52) and ends at stop 593 (P56). Mute 595 is the filtering action assigned to the navigation object and “F” word 597 is a text description of the navigation object portion 590 of the multimedia content. Like configuration 499 of FIG. 4B, configuration 599 identifies the hardware and software configuration of a consumer system to which the navigation object applies.

After the multimedia content is decoded at block 532 and transferred to the output device at block 534, the position code is updated at block 536. P51 corresponds to the updated position code. Because P51 is not within (542) the start position 591 and stop position 593 and no filtering action is active or sent (556), more multimedia content is decoded (532), transferred to the output device (534), and the position code is updated again (536).

The updated position code is now P52. P52 also marks the beginning of the navigation object portion 590 of the multimedia content defined by the start and stop positions (591 and 593) of the navigation object, as determined in decision block 542. Because not action is active or sent, decision block 552 continues by activating or sending (544) the filtering action assigned to the navigation object to mute audio content, and once again, content is decoded (532), transferred to the output device (534), and the position code is updated or queried (536).

Muting, in its most simple form, involves setting the volume level of the audio content to be inaudible. Therefore, a mute command may be sent to the output device without using the decoders. Alternatively, a mute command sent to the decoder may eliminate or suppress the audio content. Those of skill in the art will recognize that audio content may include one or more channels and that muting may apply to one or more of those channels.

Now, the updated or queried position code (536) is P53. Decision block 542 determines that the updated or queried position code (536) is within the navigation object, but an filtering action is active or has been sent (552), so block 532 decodes content, block 524 transfers content to the output device, and block 536 updates or queries the position code. The audio content continues to be decoded and the muting action continues to be activated.

At this point, the updated or queried position code (536) is P54. Now decision block 542 determines that the updated or queried position code (536) is no longer within the navigation object, but decision block 556 indicates that the muting action is active or has been sent. Block 546 activates or sends and end action to end the muting of the audio content and the decoding continues at block 532. For DVD content, the result would be that the video content is played at the output device, but the portion of the audio content containing an obscenity, as defined by the navigation object, is filtered out and not played at the output device.

Abruptly altering multimedia content may lead to noticeable artifacts that detract from the experience intended by the multimedia content. To diminish the potential for artifacts, filtering actions may be incrementally activated or separate incremental filtering action may be used. For example, a fade out (e.g., normal to no volume) filtering action may precede a mute filtering action and a fade in (e.g., no volume to normal) filtering action may follow a mute filtering action. Alternatively, the fading out and fading in may be included as part of the mute filtering acting itself, with the start and stop positions being adjusted accordingly. The length of fade out and fade in may be set explicitly or use an appropriately determined default value. Incremental filtering actions are not limited to any particular amount of change, such as normal to no volume, but rather should be interpreted to include any change, such as normal to one-half volume, over some interval. Furthermore, incremental filtering actions may adjust virtually any characteristic of multimedia content.

Like the method shown in FIG. 4A, the method shown in FIG. 5A may be practiced at both client systems and server system. However, the methods will not be described in a server system because the distinctions between a consumer system and a server system have been adequately identified in the description of FIGS. 4A and 4B.

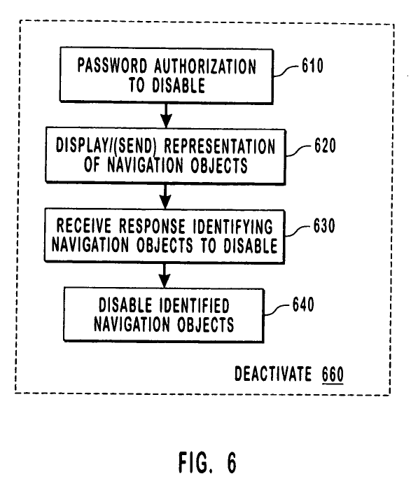

FIG. 6 is a flowchart illustrating a method used in customizing the filtering of multimedia content. At block 610, a password is received to authorize disabling the navigation objects. A representation of the navigation objects is displayed on or sent to (for server systems) the consumer system in block 620. Next, as shown in block 630, a response is received that identifies any navigation objects to disable and, in block 640, the identified navigation objects are disabled.

Navigation objects may be disabled by including an indication within the navigation objects that they should not be part of the filtering process. The act of retrieving navigation objects, as shown in blocks 422 and 522 of FIGS. 4A and 5A, may ignore navigation objects that have been marked as disabled so they are not retrieved. Alternatively, a separate act could be performed to eliminate disabled navigation objects from being used in filtering multimedia content.

The acts of receiving a password (610), displaying or sending a representation of the navigation objects (620), receiving a response identifying navigation objects to disable (630), and disabling navigation objects (640), have been enclosed in a dashed line to indicate that they are examples of acts that are included within a step for deactivating navigation objects (660). As with the exemplary methods previously described, deactivating navigation objects may be practiced in either a consumer system or a server system.

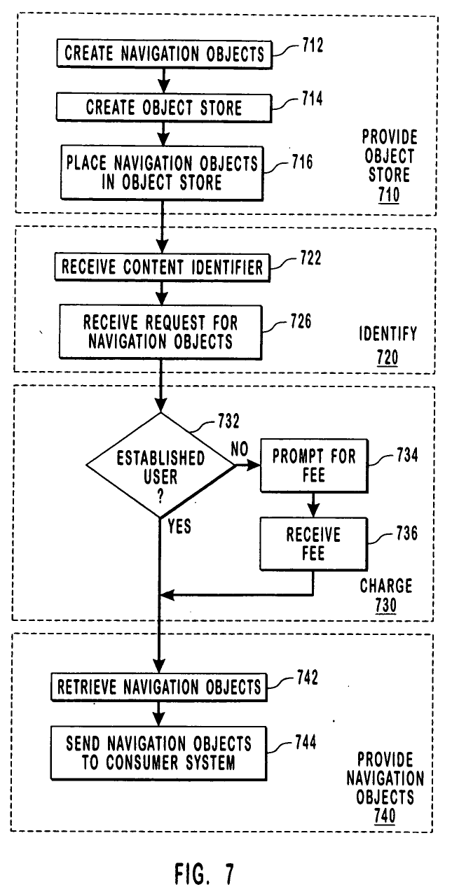

FIG. 7 illustrates an exemplary method for assisting a consumer system in automatically identifying and filtering portions of multimedia content. A step for providing an object store (710) includes the acts of creating navigation objects (712), creating an object store (714), and placing the navigation objects in the object store 716. A step for providing navigation objects (720) follows. The step for providing navigation objects (720) includes the acts of receiving a content identifier (722), such as a title, and receiving a request for the corresponding navigation objects (726).

In the step for charging (730) for access to the navigation objects, block 732 identifies the act of determining if a user has an established account. For example, if a user is a current subscriber then no charge occurs. Alternatively, the charge could be taken from a prepaid account without prompting the user (not shown). If no established account exists, the user is prompted for the fee, such as entering a credit card number or some other form of electronic currency, at block 734 and the fee is received at block 736. A step for providing navigation objects (740) follows that includes the act of retrieving the navigation objects (742) and sending the navigation objects to the consumer system (744). The act of downloading free navigation software that makes use of the navigation objects also may be included an inducement for the fee-based service of accessing navigation objects.

Further aspects of the present invention also involve a system, apparatus, and method for a user to play a multimedia presentation, such as a movie provided on a DVD, with objectionable types of scenes and language filtered. Another aspect of the invention involves a filtering format defining event filters that may be applied to any multimedia presentation. Another aspect of the invention involves a series of operations that monitor the playback of a multimedia presentation in comparison with one or more filter files, and filter the playback as a function of the filter files.

A broad aspect of the invention involves filtering one or more portions of a multimedia presentation. Filtering may involve either muting objectionable language in a multimedia presentation, skipping past objectionable portions of a multimedia presentation as a function of the time of the objectionable language or video, modifying the presentation of a video image such as through cropping, or fading, or otherwise modifying playback to eliminate, reduce, or modify the objectionable language, images, or other content. Filtering may further extend to other content that may be provided in a multimedia presentation, including close captioning text, data links, program guide information, etc.

Typically, a DVD can hold a full-length film with up to 133 minutes of high quality audio and video compressed in accordance with a Moving Picture Experts Group (“MPEG”) coding formats. One aspect of the invention involves the lack of any modification or formatting of the multimedia presentation in order for filtering to occur. To perform filtering, the multimedia presentation need not be preformatted and stored on the DVD with any particular information related to the language or type of images being delivered at any point in the multimedia presentation. Rather, filtering involves monitoring existing time codes of multimedia data read from the DVD. A filter file includes a time code corresponding to a portion of the multimedia data that is intended to be skipped or muted. A match between a time code of a portion of the multimedia presentation read from a DVD with a time code in the filter file, causes the execution of a filtering action, such as a mute or a skip. It is also possible to monitor other indicia of the multimedia data read from the DVD, such as indicia of the physical location on a memory media from which the data was read.

The term “decoding” as used herein, may broadly refer to any stage of processing between when multimedia information is read from a memory media to when it is presented. In some context, the term “decoding” may more particularly refer to MPEG decoding. In some implementations of the present invention, the comparison between a filter file and multimedia data occurs before MPEG decoding. It is possible to perform the comparison operation after MPEG decoding; however, with current decode processing platforms, such a comparison arrangement is less efficient from a time perspective and may result in some artifacts or presentation jitter.

Until the mute or time seek is executed, the DVD player reads the multimedia information from the DVD during conventional sequential play of the multimedia presentation. Thus, the operations associated with a play command on the DVD are executed. The play command causes the read-write head to sequentially read portions of the video from the DVD. As used herein, the term “sequential” is meant to refer to the order of data that corresponds to the order of a multimedia presentation. The multimedia data, however, may be physically located on a memory media in a non-sequential manner. The multimedia information read from the DVD is stored in a buffer. At this point in the processing, all multimedia information is read from the DVD and stored to the buffer regardless of whether the audio data will be muted, or portions of the video data skipped. From the buffer, the MPEG coded multimedia information is decoded prior to display on a monitor, television, or the like.

A typical DVD may have several separate portions referred to as “titles.” One of the titles is the movie, and the other titles may be behind the scenes clips, copyright notices, logos, and the like. While implementations of the present invention may be deployed to function with all possible titles, in one particular implementation, filter files are applied to time sequences of the primary movie title, e.g., the sequence of frames that is associated with a particular movie, e.g., “Gladiator” provided on DVD. The DVD specification defines three types of titles (not to be confused with the name of a movie): a monolithic title meant to be played straight through (one sequential_PGC_title), a title with multiple PGCs (program chains) for varying program flow (multiple_PGC_title), and a title with multiple PGCs that are automatically selected according to the parental restrictions setting of a DVD player (parental_block_title). One sequential PGC titles are the only type at the present time that have integrated timing data for time code display and searching. Thus, with a one_sequential_PGC_title, the multimedia information being read from the DVD includes a time code. For other filter types, it is possible to generate timing information and associate that timing information with particular playback paths. Some specific implementations of the present invention function with one-sequential_PGC_titles.

In one aspect, the time code for the multimedia information read from a memory media and stored in a memory buffer is compared to filter files in a filter table. A filter table is a collection of one or more filter files for a particular multimedia presentation. A filter file is an identification of a portion of a multimedia presentation and a corresponding filtering action. The portion of the multimedia presentation may be identified by a start and end time code, by start and end physical locations on a memory media, by a time or location and an offset value (time, distance, physical location, or a combination thereof, etc.). A user may activate any combination of filter files or no filter files. Table 1 below provides two examples of filter files for the movie “Gladiator”. A filter table for a particular multimedia presentation may be provided as a separate file on a removable memory media, in the same memory media as the multimedia presentation, on separate memory media, or otherwise loaded into the memory of a multimedia player configured to operate in accordance with aspects of the invention.

TABLE 1
Filter Table with example of two Filter
Files for the Film Gladiator

| | | | Dura- | Filter | |
|---|---|---|---|---|---|
| Filter | Start | End | tion | Action | Filter Codes |
| 1 | 00:04:15:19 | 00:04:48:26 | 997 | Skip | 2: V-D-D, V-D-G |
| 2 | 00:04:51:26 | 00:04:58:26 | 210 | Skip | 1: V-D-G |

Referring to Table 1, the first filter file (1) has a start time of 00:04:15:19 (hour:minute:second:frame) and an end time of 00:04:48:26. The first filter file further has a duration of 997 frames and is a “skip” type filtering action (as opposed to a mute). Finally, the first filter file is associated with two filter types. The first filter type is identified as “V-D-D”, which is a filter code for a violent (V) scene in which a dead (D) or decomposed (D) body is shown. The second filter type is identified as “V-D-G”, which is a filter code for a violent (V) scene associated with disturbing (D) and/or gruesome (G) imagery and/or dialogue. Implementations of the present invention may include numerous other filter types. During filtered playback of the film “Gladiator,” if the “V-D-D”, “V-D-G,” or both filter files are activated, the 997 frames falling between 00:04:15:19 and 00:04:48:26 are skipped (not shown). Additionally, if the V-D-G filter file is activated, the 210 frames falling between 00:04:51:26 and 00:04:58:26 are skipped.

Tables 2 and 3 below provide examples of various possible filter types conforming to the present invention. Other filter types may be implemented in various embodiments of the present invention.

TABLE 2
Filter Types and Associated Description
of Content of Scene for each Filter Type

| Filter | Filter | |
|---|---|---|
| Code | Classification | Filter type |
| S-P-S | Sex/Nudity | Sensual Dialogue/Situation |
| S-P-C | Sex/Nudity | Provacative/Revealing Clothing |
| S-P-I | Sex/Nudity | Provocative Innuendo |
| S-C-W | Sex/Nudity | Crude Sexual Word/Dialogue |
| S-C-A | Sex/Nudity | Crude Sexual Action/Gesture |
| S-C-I | Sex/Nudity | Crude Sexual Innuendo |
| S-S-SS | Sex/Nudity | Sex Scene |
| S-S-SR | Sex/Nudity | Sex Related Sounds/Dialogue |
| S-S-A | Sex/Nudity | Sexually Explicit Actions/Images |
| S-N-R | Sex/Nudity | Rear Nudity |
| S-N-T | Sex/Nudity | Topless/Front Nudity |
| S-N-P | Sex/Nudity | Partial Nudity/Veiled Nudity |
| S-N-A | Sex/Nudity | Nude Photos/Art |
| V-S-F | Violence/Gore | Strong Fantasy/Creature Violence |
| V-S-A | Violence/Gore | Strong Action Violence |
| V-S-E | Violence/Gore | Excessive/Repeated Violence |
| V-S-C | Violence/Gore | Crude Comic Violence |
| V-G-B | Violence/Gore | Brutal Violence |
| V-G-G | Violence/Gore | Graphic Bloody Violence |
| V-G-D | Violence/Gore | Disturbing Violence |
| V-G-R | Violence/Gore | Rape/Rape Scene |
| V-G-T | Violence/Gore | Torture |
| V-D-D | Violence/Gore | Dead/Decomposed Body |
| V-D-V | Violence/Gore | Graphic Vomit/Urine/Saliva/Mucus |
| V-D-B | Violence/Gore | Strong Bloody Imagery |
| V-D-G | Violence/Gore | Disturbing/Gruesome Imagery/Dialogue |
| L-C-W | Language and | Crude Scatological Word/Sounds |
| | Crude Humor | |
| L-C-A | Language and | Crude Scatological Image/Dialogue |
| | Crude Humor | |
| L-R-M | Language and | Rude/Malicious Name Calling (Limited to |
| | Crude Humor | Child Targeted Movies) |
| L-E-R | Language and | Racial Slurs |
| | Crude Humor | |
| L-E-S | Language and | Social Slurs |
| | Crude Humor | |
| L-H | Language and | Hell |
| | Crude Humor | |
| L-H-d | Language and | Damn |
| | Crude Humor | |
| L-D | Language and | Vain reference to a god or deity |
| | Crude Humor | |
| L-P- | Language and | Strong Profanity |
| | Crude Humor | |
| Ba/Bi | Language and | B*stard/B*tch |
| | Crude Humor | |
| A/S/Fi/ | Language and | A**/Sh**/Finger |
| | Crude Humor | |
| L-V-F | Language and | F*** |
| | Crude Humor | |
| L-V | Language and | Graphic/Vulgar Words |
| | Crude Humor | |
| D-D | Other Content | Explicit Drug Use/Dialogue |
| D-R | Other Content | Reference to Use of Drugs |

Table 2 provides a list of examples of filter types that may be provided individually or in combination in an embodiment conforming to the invention. The filter types are grouped into five broad classifications, including: Sex/Nudity, Violence/Gore, Language and Crude Humor, and Mature Topics. Within each of the four broad classifications, are a listing of particular filter types associated with each broad classification. In a filter table for a particular multimedia presentation, various time sequences (between a start time and an end time) of a multimedia presentation may be identified as containing subject matter falling within one or more of the filter types. In one particular implementation, multimedia time sequences may be skipped or muted when particular filter files are applied to a multimedia presentation. Alternatively, or additionally, multimedia time sequences may be skipped or muted as a function of a broad classification, e.g., Violence/Gore, in which case all portions of a multimedia presentation falling within a broad filter classification will be skipped or muted.

TABLE 3
Filter Types and Associated Description
of Content of Scene for each Filter Type

| | Filter | | |
|---|---|---|---|
| Filter | Classifi- | | |
| Code | cation | Filter type | Filter Action |
| V-S-A | Violence | Strong Action | Removes excessive violence, |
| | | Violence | including fantasy violence |
| V-B-G | Violence | Brutal/Gory | Removes brutal and graphic |
| | | Violence | violence scenes |
| V-D-I | Violence | Disturbing | Removes gruesome and other |
| | | Images | disturbing images |
| S-S-C | Sex and | Sensual | Removes highly suggestive and |
| | Nudity | Content | provocative situations and |
| | | | dialogue |
| S-C-S | Sex and | Crude Sexual | Removes crude sexual language |
| | Nudity | Content | and gestures |
| S-N | Sex and | Nudity | Removes nudity, including |
| | Nudity | | partial and art nudity |
| S-E-S | Sex and | Explicit | Removes explicit sexual |
| | Nudity | Sexual | dialogue, sound and actions |
| | | Situation | |
| L-V-D | Language | Vain | Removes vain or irreverent |
| | | Reference | reference to Deity |
| | | to Deity | |
| L-C-L | Language | Crude | Removes crude sexual language |
| | | Language | and gestures |
| | | and Humor | |
| L-E-S | Language | Ethnic and | Removes ethnically or socially |
| | | Social Slurs | offensive results |
| L-C | Language | Cursing | Removes profane uses of |
| | | | “h*ll” and “d*mn” |
| L-S-P | Language | Strong | Removes swear words, |
| | | Profanity | including strong profanities |
| L-G-V | Language | Graphic | Removes graphic vulgarities, |
| | | Vulgarity | including “f***” |
| O-E-D | Other | Explicit | Removes descriptive scenes |
| | | Drug Use | of illegal drug use |

Table 3 provides a list of examples of filter types that may be provided individually or in combination in an embodiment conforming to the invention. The filter types are grouped into five broad classifications, including: Violence, Sex/Nudity, Language, and Other. Within each of the four broad classifications, are a listing of particular filter types associated with each broad classification. In a filter table for a particular multimedia presentation, various time sequences (between a start time and an end time) of a multimedia presentation may be identified as containing subject matter falling within one or more of the filter types. In one particular implementation, multimedia time sequences may be skipped or muted as a function of a particular filter type, e.g., V-S-A. Alternatively, or additionally, multimedia time sequences may be skipped or muted as a function of a broad classification, e.g., V, in which case all portions of a multimedia presentation falling within a broad filter classification will be skipped or muted.

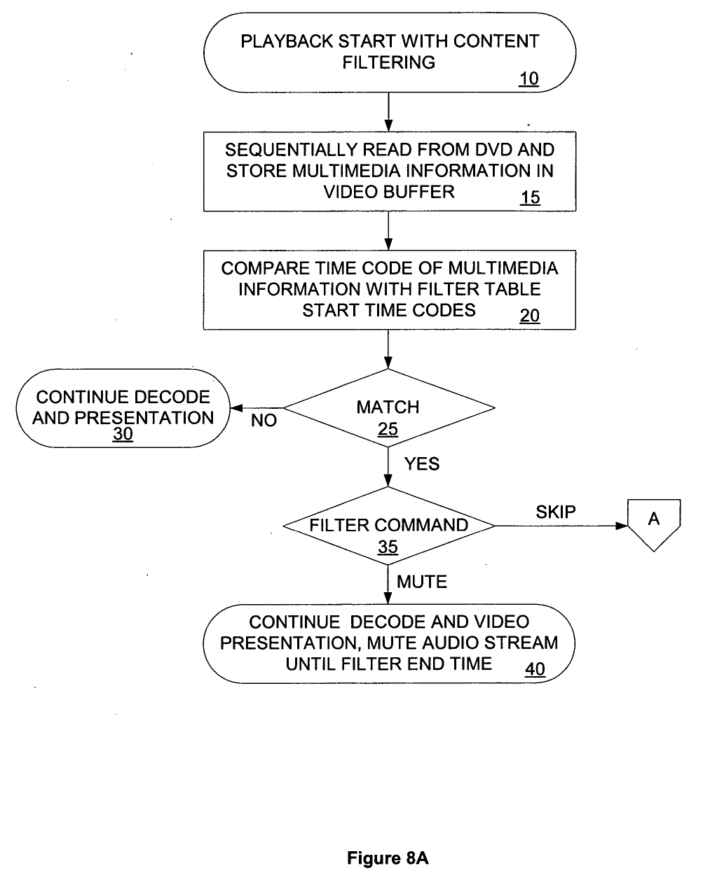

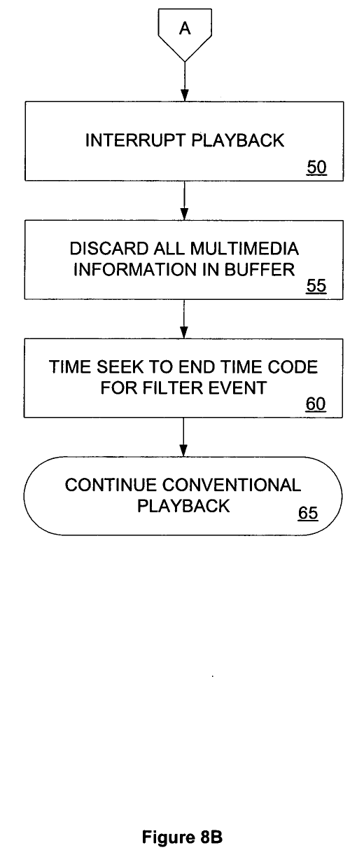

FIGS. 8A and 8B illustrate a flowchart of the operations involved with application of a filter file to a DVD-based multimedia presentation, such as a movie, being played on a DVD player. In one example, filtration monitoring begins upon play of a multimedia presentation (operation 10). Thus, in one example, when a user pressed the “play” button on the DVD-player or the “play” button on a remote control for the DVD-player, play is started. “Play” in the context of a movie, involves the coordinated video and audio presentation of the movie on a display. As discussed in greater detail below, before depressing “play” the user first activates one or more filter types for the movie. Moreover, if the movie's filter table is not already present in memory of the multimedia player, e.g., DVD player, then the user must first load the filter table in memory, or the multimedia player must first obtain the filter table, such as through some form of automatic downloading operation.

As introduced above, during playback, the multimedia information is read from the DVD and stored in a buffer (operation 15). The multimedia information stored on the DVD is arranged in a generally hierarchical manner according to the DVD specifications. Some implementations of the present invention operate on a portion of the multimedia data referred to as a video object unit (“VOBU”). The VOBU is the smallest unit of playback in accordance with the DVD specifications. However, in some implementations of the present invention, the smallest unit of playback is at the frame level. A VOBU is an integer number of video fields typically ranging from 0.4 to 1 second in length, typically about 12-15 frames. Thus, playback of a VOBU may be accompanied by between 0.4 to 1 second of video, audio, or both. A VOBU is a subset of a cell. Generally speaking, a cell is comprised of one or more VOBUs and is generally characterized as a group of pictures or audio blocks and is the smallest addressable portion of a program chain. Playback may be arranged through orderly designation of cells.

During playback (after the multimedia is read from the memory media, but before presentation), some implementations of the present invention monitor the time code of the next multimedia information to be read out of the buffer for decoding and presentation. For DVD-based information, a VOBU presentation time stamp (time code) is monitored. The time code may integral with the multimedia data stored on the memory media, such as in the case of the presentation time stamp of a VOBU. For other multimedia formats, it is possible to separately track the multimedia information being read form the memory media, and associate the multimedia information with a separately generated time code. The time code information may also be a function of the system clock. The buffer (sometimes referred to as a “track” buffer) is a memory configured for first-in-first-out (FIFO) operation. The term buffer may refer to any memory medium including RAM, Flash Memory, et. As such, multimedia data read into the buffer is read out of the buffer in the same sequence it arrived. In one particular implementation, the filter comparison occurs after the multimedia is read from memory (e.g. DVD), but before it is decoded. In such an implementation, the time code of the VOBU about to be transmitted from the buffer for decoding (the VOBU at the front of the FIFO buffer), is compared with the start times of the filters identified in the filter table for the multimedia presentation (operation 20). If there is not a match (operation 25), then sequential decoding and presentation of information in the buffer continues normally (operation 30).

If there is a match (operation 25), then the type of filter event is determined (e.g., mute or skip) (operation 35). For a mute, video image playback is continued normally, but some or all of the audio portion is muted until the event end time code (operation 40). Muting of the audio accounts for an analog audio output, a digital audio output, or both. For audio muting, the amplitude of the audio signal is reduced to zero for the duration of the mute. For digital muting, the digital output is converted to digital Os for the duration of the mute.

FIG. 3B is a flowchart illustrating the operations involved with a skip. To execute a skip type filtering action, playback is interpreted (operation 50). Next, the buffer is reset (operation 55). A reset of the buffer may be characterized as deleting all information in the buffer or “emptying” the buffer. After a reset, all new information read into the buffer starts at the first memory address. Resetting the buffer may be accomplished in various ways, such as resetting a buffer address pointer (where the next information read from the DVD will be stored) to the first address of the buffer (i.e., allowing existing buffer data to be overwritten).

Next, the DVD read unit is commanded to begin reading the frame associated with the filter end time code (operation 60). As discussed in further detail below, the start and end of a filter file may also be designated with other values or combinations of values, besides a time code. The frame associated with the filter end time code, is sent to the first memory location in the buffer and playback starts again with the frame following the end time, which is decoded and displayed with the associated audio (operation 65).

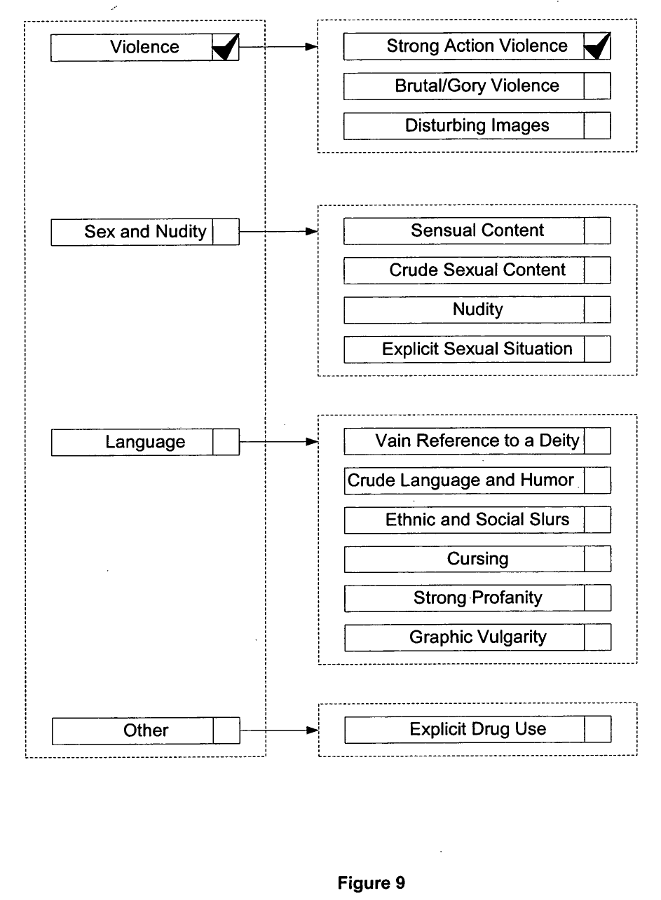

FIG. 9 is a block diagram illustrating one possible example of an organization of on-screen menus for activating one or more filters. The menus are shown in one drawing, but may be presented in separate screens in implementations conforming to aspects of the invention. A first menu displays one or more filter classifications. The example of FIG. 9 corresponds with Table 3, there are four filter classifications, including: violence, sex and nudity, language, and other. In this example menu arrangement, filters files may not be activated based-on selecting a classification, rather the classifications are used to access a set of filters that correspond with the classification. Thus, by selecting a classification, a second filter menu is displayed with a set of filters corresponding with the selected classification. In the example of FIG. 9, by selecting the “violence” classification, an on-screen menu with three violence types filters are displayed. The violence type filters, may be those of Tables 2, 3, or any other arrangement. FIG. 9 illustrates the “violence” filters of Table 3, including: strong action violence, brutal/gory violence, and disturbing images. In the example of FIG. 9, the user selected the “strong action violence” filter, which activates the “strong action violence filter.” However, it is possible to activate a set of filter files based on activating a filer classification. For example, by activating the “violence” filter classification, the “strong action violence,” “brutal/gory violence,” and “disturbing images” filter files would be activated.

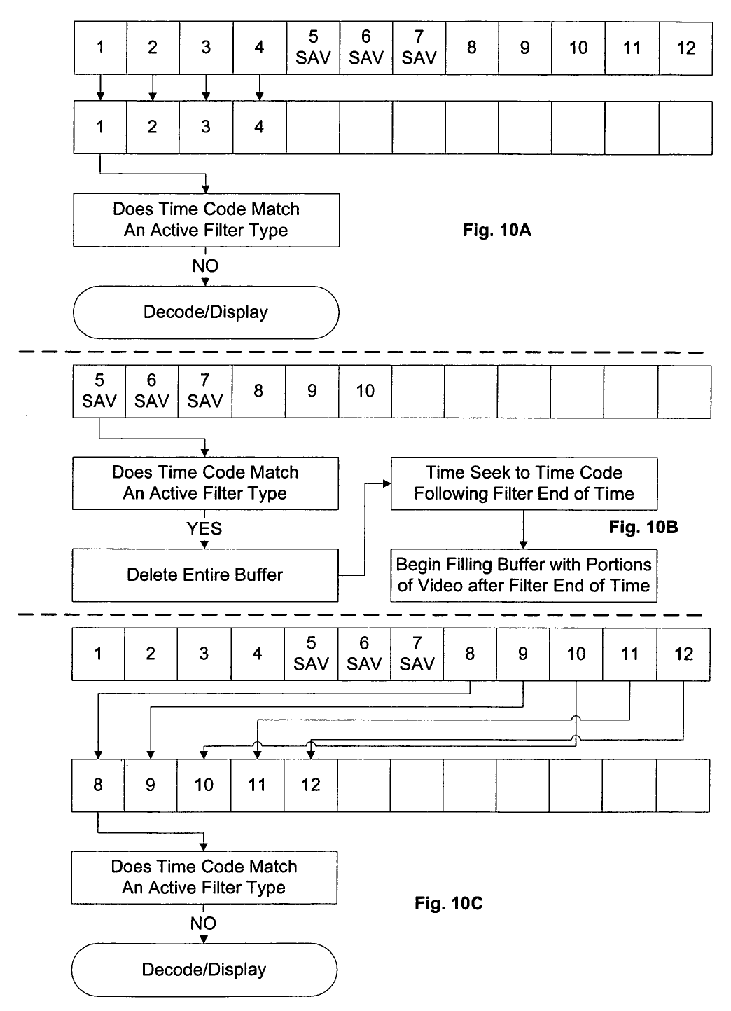

FIGS. 10A-10C are block diagrams/flow charts illustrating playback of twelve 12 portions of a multimedia presentation with the “strong action violence” filter activated, and with three portions of the multimedia (portions 5, 6, and 7) having been identified as having strong action violence (“SAV”). As mentioned above, the multimedia presentation need not be modified to associate particular portions with particular filter types, or modified to associate particular portions with some form of subject matter identifier. Rather, a filter table is provided separately from the multimedia presentation. The filter table has one or more filter entries, and each filter file is arranged with start and end identifiers for portions of the multimedia presentation. Certain broad aspects of the invention, such as reading multimedia presentation information from a memory media before filter processing, deleting all buffer contents to achieve a skip, etc., may be implemented regardless of whether the multimedia is coded with filter identifiers or otherwise modified with some form of subject matter identifier.

Referring first to FIG. 10A, the first four portions of the multimedia presentation are read from a memory media, such as a DVD, and stored in a buffer. The portions are read out of the buffer in the order they arrived, i.e., portions 1-4 are read from the buffer beginning with portion 1 and ending with portion 4. The time code of each portion is compared with a filter table, and if there is no match, the portion is read from the buffer, decoded, and displayed. As such, portions 1-4 are each compared with a filter table, and because the time codes of the portions do not match a filter time code (or other start and end identifiers), the four portions are read out of the buffer, decoded, and displayed.

Referring now to FIG. 9B, when multimedia portion 5 reaches is at the front of the buffer, it is compared with the filter table. Portions 5-7 of the multimedia presentation contain “strong action violence.” As such the filter table includes a filter entry corresponding with the start time of multimedia portion 5 and an end time of multimedia portion 7. Portions 5-7 will be skipped (not shown). To skip portions 5-7, all of the information in the buffer is deleted. In the example of FIG. 9B, portions 5-7 and portions 8-10 have been read into the buffer. Alternatively, only the buffer contents associated with skipped multimedia data are deleted (e.g., portions 5-7). In such an implementation, the buffer portion may be reset to portion 8. Further, in such an implementation DVD read head control may be reduced or eliminated. Portions 8-10 do not contain strong action violence. Nonetheless, portions 8-10 are deleted from the buffer. After the buffer is deleted (reset), a time seek command to the filter end time code is executed. The time seek command causes the memory media to begin reading information from the media and into the buffer beginning with portion 8.

As shown in FIG. 9C, multimedia portions 8-12 are read from the media and stored in the buffer. Because the time codes of multimedia portions 8-12 are not associated with a strong action violence filter, multimedia portions 8-12 are read from the buffer, decoded, and displayed.

In the case of a DVD-based implementation, the filtering is applied against a conventional DVD-based multimedia presentation, i.e., the DVD title does not require any special formatting beyond that provided in accordance with conventional DVD specifications. To identify objectionable content and define a filter event, a person plays and views the video and identifies objectionable content by way of the start and end identifiers of the objectionable content. A particular range of multimedia (bounded by start and end identifiers) of a DVD title may be classified as any one or combination of filter files. Before filtered playback from a DVD player configured in accordance with aspects of the present invention, a filter table is loaded into a memory of the DVD player.

A DVD player may be configured to access a filter table by way of a network connection with a server providing filter files, by way of a removable memory media, (e.g., DVD, CD, magnetic disc, memory card, etc.) either separate from the movie title or on the same memory media as the movie title, or in other ways. Particular examples of network-based access to filters tables or other access is described in U.S. provisional patent application No. 60/620,902 filed Oct. 20, 2004, and U.S. provisional patent application No. 60/641,678 filed Jan. 5, 2005, both of which are hereby incorporated herein by reference.

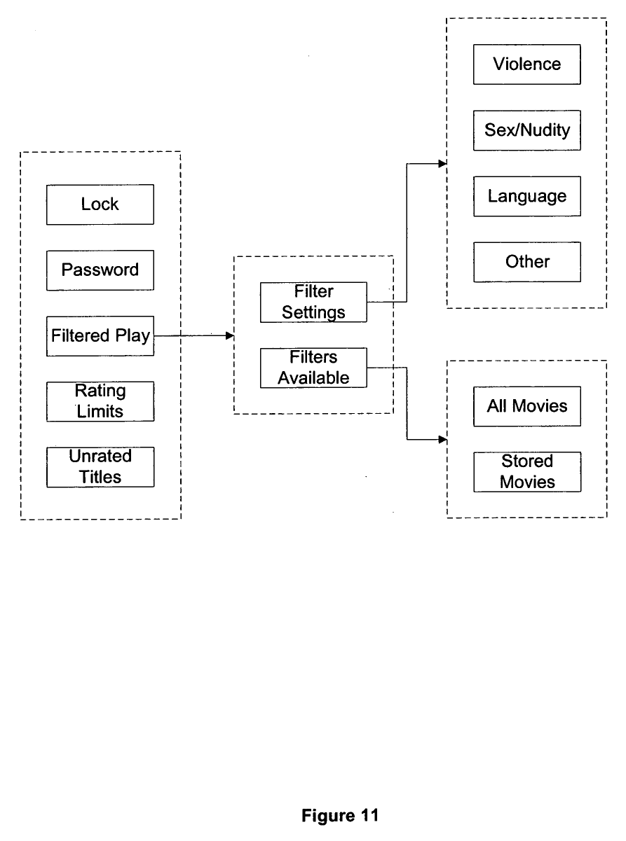

FIG. 11 is a block diagram illustrating one possible multimedia player on-screen menu organization. Access to the filtering menus is provided in a parental control menu. The parental control menu is a conduit to various parent control functions, including conventional parental control features and parent control functionality conforming to aspects of the present invention. In the example of FIG. 11, the multimedia player is configured with a conventional “lock” parent control feature, a conventional “password” parental control feature, the filtering functionality conforming to aspects of the invention, a conventional “rating limits” parental control feature, and a conventional “unrated titles” parental control feature. By selecting, “lock”, “password”, “rating limits” or “unrated titles”, the multimedia player accesses a particular menu or collections of menus associated with each selection. Generally, the “lock” feature allows a user to lock the DVD player, which prohibits functionality unless a correct user identification and password are entered. The password menus provide the user with a means for setting up or changing a password. The “rating limits” feature allows a user to prohibit viewing of titles that exceed certain ratings. The rating limits feature may be aligned with MPAA (G/PG/PG-13/R/NC-17) ratings. So, for example, viewing of R-rated and above titles is prohibited. The rating limits feature may be activated on a user by user basis, with particular rating limits applied to different users. Rating limits functionality may be implemented by way of V-chip technology. The “unrated titles” feature allows a user to either prohibit or allow play of unrated titles. Some titles are not rated; thus, the rating limits feature would not function to prohibit or allow unrated title viewing.

Selection of the “Filtered Play” button, causes the multimedia player to load a “Filtered Play” menu. The user may navigate through the on-screen menus by way of the arrow keys on a remote, and may navigate between menus by selecting “enter” on the remote when a particular menu button is highlighted. The Filtered Play menu has a “Filter Settings” button and a “Filters Available” button. The Filter Settings button provides access to the filter selection menus, one example of which is illustrated in FIG. 9. The Filters Available button provides access to the Filter Library menu. The Filter Library menu provides a list of all filters currently in the multimedia player memory, the list is organized in alphabetical order by movie title. The Filter Library menu also provides a list of filters available to download. Whenever new filter files are downloaded to the multimedia player, a file is included that lists all possible movie titles for which filter files are available. Thus, the list of available filter files is only current as of the date that the filters were downloaded. With a network connection, it is possible to update the filer list on a regular basis so that the list is always current.

If the multimedia player already includes a filter table in memory, then the user need only activate filtering, and then proceed to filtered playback. If a filter table is not already in memory, then the user uploads the filter table to memory before filtered playback. Alternatively, the user may proceed to activate certain filter types, and proceed to filtered playback without first determining whether filters for a particular multimedia title are available. In the case of a DVD-based movie, the DVD typically has title information accessible by a DVD player. Before filtered playback, the DVD player compares the movie title to a list of filter tables loaded in memory. If there is not a match, then the user may be prompted to load the filter table for the movie title in memory.

Once a filter table is identified for a particular movie title intended for playback, the user is prompted to activate or deactivate the filter types for the movie. The user will be presented with a filter selection menu, such as shown in FIG. 9, unless filters have already been activated.

As mentioned above, the movie itself is not altered, in some embodiments of the present invention. Rather, portions of a movie are identified in a filter table. In one example, a portion of a multimedia presentation is identified as a range of time falling between the start and end time of a particular filter file. For example, if strong action violence occurs in a movie between the times of 1:10:10:1 (HH:MM:SS:FF) and 1:10:50:10, then a filter file for the movie will have a filter with a start time of 1:10:10:1 and an end time of 1:10:50:10. The filter file will include also include an identifier associated with “strong action violence” such as “S-A-V.” Thus, if a use activates the strong action violence filter file type, when a portion of the multimedia presentation including 1:10:10:1 is in the buffer, the buffer will be deleted. Thus, all information in the buffer, which includes the portion of the multimedia presentation having strong action violence, is deleted. The buffer may also have portions of the multimedia presentation that will be shown. Reading of the multimedia content from the memory media then restarts with the next portion of multimedia following the filter end of time. The portions of multimedia following the filter end time are read into the buffer, decoded, and presented. Due to the speed at which the DVD read head may move to the new media location and read information into the buffer, and also be decoded, it is possible to take such operations without noticeable on-screen artifacts (i.e., the skipping operation may be visibly seamless).

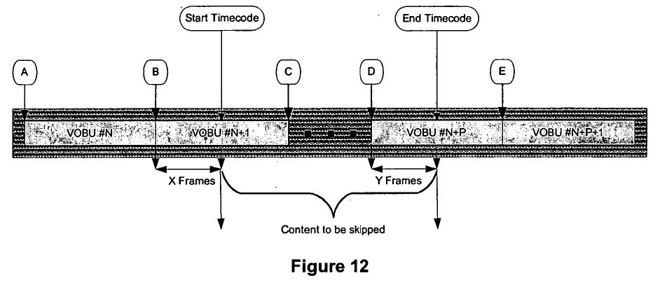

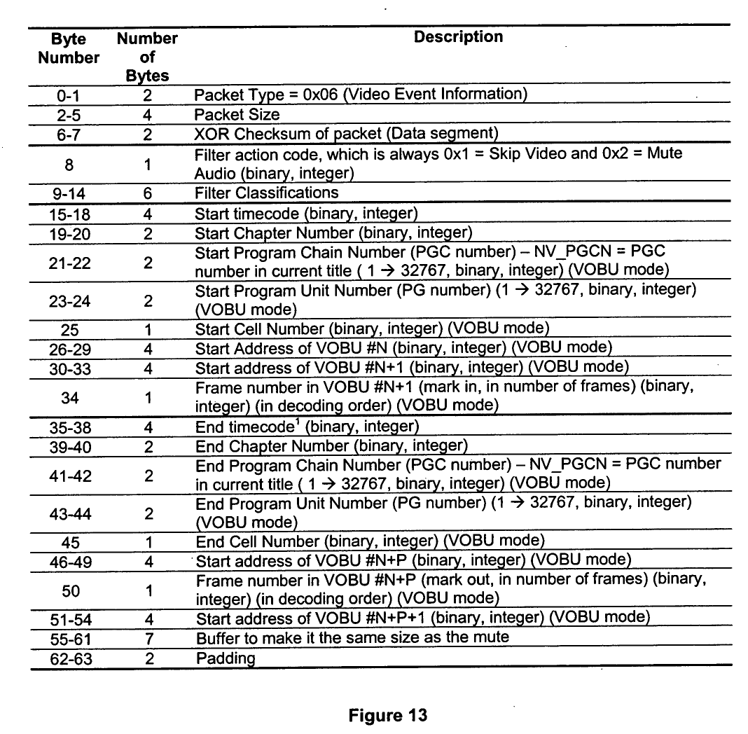

FIG. 12 is a graphical illustration of one example of the format of a skip type filtering action. FIG. 13 is a table identifying one example of the file format for a skip type filtering action. The file format represents one filter file in a filter table. Referring first to the graphical illustration of a skip presented in FIG. 12, a skip type filter file includes a start time code and an end time code. The start time code of a skip filter file occurs within VOBU N+1, which follows VOBU N. The actual frame associated with the start time code is X frames from the beginning of VOBU N+1. The end time code of the skip is occurs within VOBU N+P, which is followed by VOBU N+P+1. The actual frame associated with the end time code is Y frames from the beginning of VOBU N+P. The start and end times, may be identified by time code (e.g., HH:MM:SS:FF) or by more particular hierarchical DVD information, discussed in greater detail below, or combination thereof. In this example, VOBU N and VOBU N+P+1 are played (both audio and video) in their entirety. The first X frames of VOBU N+1 are played, and the remainder of VOBU N+1 is skipped. The first Y frames of VOBU N+P are skipped, and the remaining frames of VOBU N+P are played. All frames associated with any VOBU(s) falling between VOBU N+1 and VOBU N+P are skipped.

Referring now to FIG. 12, the table illustrates the file format for a skip type filter file, in accordance with one example of the present invention. The table is organized by file format byte allocation in the left column, followed by an indication of a number of bytes for each allocation, followed by a description of the byte designations. The file format is one example of a filter file format conforming to aspects of the invention. A file format conforming to aspects of the invention may include some or all of the identified bytes designation, may include different byte arrangements, numbers of bytes for each designation, and other combinations and arrangements. Bytes 0-7 involve packet identifiers. Byte 8 is a filter action code, with 0x1 indicating a skip action, and 0x2 indicating a mute action. Bytes 9-14 are reserved for filter classifications and particular filter types, such as the various classification and types discussed herein. Referring first to byte 8, it is one byte in length and identifies the event action code (e.g., skip or mute). Bytes 9-14 are coded to identify the event classification for each possible combination of event classifications, such as is shown in Table 2. When the a filtering method as discussed herein operates, a comparison is made between the filter types activated by a particular user and the filter classifications identified in bytes 9-14.

Bytes 15-34 are identifiers for a filter start location. The designations in bytes 15-34 may be used alone or in combination to identify the start of a filtering action. Bytes 35-38 are identifiers for a filter end location. The designations in bytes 35-38 may be used alone or in combination to identify the end of a filtering action. Bytes 15-18 identify the start time code of a particular filter. Bytes 19-34 are also related to the start time of a filter, but provide more particular information concerning the exact location of the VOBU, which may be associated with the start time code or separate/independent. Bytes 35-38 identify the end time code of a filter. Bytes 39-54 are also related to the end time of the filter, but provide more particular information concerning the exact location of the VOBU associated with the end time code. Bytes 55-63 involve buffering and padding.

Bytes 15-18 are reserved for the filter start time code (HH:MM:SS:FF), byte 15 has hour information, byte 16 has minute information, byte 17 has second information, and byte 18 has frame information. Filtering may proceed, in some implementations of the present invention, with only the start and end time code information. For comparison, the time code may be converted to the same format as a VOBU presentation time stamp. A VOBU is made up of a sequence of frames, typically 12 to 15 frames. Thus, the hour, minute, and second information may be used to identify a VOBU, and the frame information used to designate a particular frame in the VOBU. To perform a skip, the DVD player is commanded to momentarily stop playback when the start time code is encountered in the multimedia information read from a memory media, and restart playback beginning with the frame identified with the end time code.

In some instances, such as when the end time code is more than 7.5 seconds from the start time code, performing a skip with only time code information may result in some artifacts. VOBUs include time code information and also pointers to other VOBUs at various granularity. So, artifacts may depend on VOBU pointer granularity. Thus, to time seek to the end time code and restart playback, the DVD player may need to read some information from the DVD player to determine whether the VOBU being read includes the frame associated with the end time code. It is possible to read a number of VOBUs and assess time code information until the VOBU with the end time frame is identified, without noticeable artifacts. However, if the skip is long, then many VOBUs may need to be read before the end time frame is located. In such instances, due to the lengthy searching process, a short screen freeze may be visible.

To avoid or substantially reduce artifacts or the freezing of the image on the screen, it is possible to identify the exact location on the memory of the target VOBU (the VOBU having the frame associated with a filter end time). Such precise definition allows the DVD player to avoid searching for the target VOBU. As such, the skip file format may include bytes 19-34 that identify the start chapter number, start program chain number, start program unit number, start cell number, start address of VOBU N, start address of VOBU N+1, and frame number associated with the X frames offset from the beginning of VOBU N+1 associated with the start time for the filter event. Bytes 19-34 refer to various hierarchical information as defined in various DVD specifications.

A VOBU includes both a time code and a logical block number. As discussed above, the time code represents the time at which the compressed multimedia information within the VOBU is intended for playback. A filter file may identify a portion of a multimedia presentation based on time, and identify portions of the multimedia presentation by monitoring the time codes of VOBUs read from a DVD. The logical block number is an identifier of a particular physical memory location on a DVD where the information for the VOBU is stored. The physical location on the DVD may also be used in a filter file to identify the start and end of a portion of a multimedia presentation. In such a case, the physical location identifier of a filter file is compared with the physical location information of a VOBU. Thus, filter start and end identifiers may comprise the information of the start address of VOBU N+1, bytes 30-33 (the VOBU having the frame associated with the start of a filtering action). Filtering based on physical location as opposed to time code, has the benefit of completely or substantially avoiding translating the end time code information to a physical location on the DVD. Further, filtering based on physical location is advantageous for filtering a multimedia presentation on a memory that has multiple multimedia presentations. In such a case, the physical location is associated with a particular multimedia presentation, whereas a time value may require additional processing to ensure it is properly applied against the appropriate multimedia presentation.

Filtering based on only the VOBU information will have a granularity of the number of frames within the VOBU, typically 12-15 frames as mentioned above. For increased granularity to the frame level, a frame offset value may be used. The frame offset value designates a particular frame within a VOBU at which filtering begins, and also allows for frame-based playback control. Filtering based on VOBU and offset uses both the VOBU start address (bytes 30-33) and the offset value (byte 34). Alternatively, the offset value may be extracted from the frame field of the time code.

The VOBU (VOBU N) preceding the VOBU where a skip begins (VOBU N+1) or other preceding VOBUs, may be helpful in identifying the target VOBU (where the skip begins) in fast forwarding or other operations. In some fast forwarding, not all VOBUs are retrieved from the DVD. In a case where filtering is applied in normal play as well as fast forward, the presence of one or more preceding VOBUs allows the system to identify the target VOBU in the case where the target VOBU might otherwise not be retrieved, and thus not available for comparison to the filter files.

The start cell number filter identifiers, may be used to identify a particular cell in the DVD at which a target VOBU occurs. A cell includes a number of VOBUs. It is possible to identify the start of a skip operation by a cell number and a VOBU within the cell.

Referring first to byte 8, it is one byte in length and identifies the event action code (e.g., skip or mute). Bytes 9-14 are coded to identify the event classification for each possible combination of event classifications, such as is shown in Table 2. When the a filtering method as discussed herein operates, a comparison is made between the filter files activated by a particular user and the filter classifications identified in bytes 9-14. Referring first to byte 8, it is one byte in length and identifies the event action code (e.g., skip or mute). Bytes 9-14 are coded to identify the event classification for each possible combination of event classifications, such as is shown in Table 2. When the a filtering method as discussed herein operates, a comparison is made between the filter files activated by a particular user and the filter classifications identified in bytes 9-14.

Multimedia information stored on a DVD is arranged hierarchically. The hierarchy includes chapter information, which is divided into program chains, which is divided into program units, which is divided into cells. Cells are made up of a number of VOBUs. Thus, by identifying one or more or a combination of chapter, program chain, program unit, and cell, any particular VOBU may be precisely located without querying preceding VOBUs. In some implementations, an offset to the VOBU may be used with the DVD hierarchical information. Additional details on the hierarchical arrangement of information on a DVD as well as other general information about DVD technology and DVD file format specifications may be found in “DVD Demystified, second addition” by Jim Taylor, copyright 2001, 1998 by the McGraw-Hill Companies, Inc., the entirety of which is hereby incorporated by reference.

The end time code and related time coding information is identified in bytes 35-54. Bytes 35-38 are reserved for the actual event end time code (HH:MM:SS:FF), while bytes 39-54 are reserved for identifying the end chapter number, end program chain number, end program unit number, end cell number, end address of VOBU N+P, and frame number associated with the Y frames offset from the beginning of VOBU N+P associated with the end time for the filter event, and the start address of VOBU N+P+1. Bytes 55-61 are reserved for a buffer, to make the skip event filter descriptor of the same size as an audio mute filter descriptor, and bytes 62-63 are used for padding.

A DVD player or other device, memory, storage media, or processing configuration, configured to provide, play, display or otherwise work with a DVD or other audio/visual recording device, incorporating some or all features of the skip and mute file formats may fall within the scope of some or all aspects of the present invention.

In some implementations, the possibility of artifacts or screen jitters and hesitation, may be further minimized or eliminated, by skipping to a particular frame type. MPEG encoding provides I frames, B frames, and P frames. An I frame includes all of the information necessary to decode and present the frame. B and P frames, on the other hand, rely on information present in another frame for proper presentation. As such, in a skip, it is sometimes preferable to skip to an I frame, when possible. It is possible to skip to B and P frames, however, in some instances, decoding of other frames, such as an I frame, may be necessary in order to present the B or P frame.

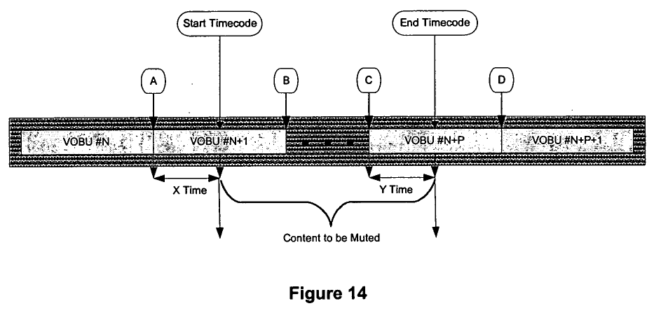

FIG. 13 is a graphical illustration of one example of the format of a mute type filtering action. FIG. 14 is a table identifying the file format for one example of a mute event. Referring first to the graphical illustration of a mute presented in FIG. 13, a mute type filter, like a skip, includes a start time code and an end time code. The start time code of the mute is shown as occurring within VOBU N+1, which follows VOBU N. The actual frame associated with the start time code is X frames from the beginning of VOBU N+1. The end time code of the mute is shown as occurring within VOBU N+P, which is followed by VOBU N+P+1. The actual frame associated with the end time code is Y frames from the beginning of VOBU N+P. The start and end times, may be identified by time code (e.g., HH:MM:SS:FF) or by more particular hierarchical DVD information, discussed in greater detail below. In this example, VOBU N and VOBU N+P+1 are played (both audio and video) in their entirety. The first X frames of VOBU N+1 are played, and the audio of the remainder of VOBU N+1 is muted, but the video is played. The audio of the first Y frames of VOBU N+P are muted (with the video played), and the remaining frames of VOBU N+P are played. All audio of the frames associated with any VOBU(s) falling between VOBU N+1 and VOBU N+P is muted, and the video is played.

The table of FIG. 14 is organized by file format byte allocation in the left column, followed by an indication of a number of bytes for each allocation, followed by a description of the byte designations. Much of the byte allocations for a mute type filter are the same as a skip type filter. Only the differences are discussed herein. Byte 15 identifies the audio channels to mute. In this implementation, seven channels of audio are provided for, and muting of any combination of channels may be specified in any particular filter. Each byte is eight bit, a digital 1 indicates a mute and a 0 indicates no mute. The following is the bit map between bits and the audio channel: Bit 0=front center channel, bit 1=front right channel, bit 2=front left channel, bit 3=rear right channel, bit 4=rear left channel, bit 5=rear center channel, bit 6=sub woofer, bit 7 is not used. Thus, for example, with 10000000, only the front center channel is muted, and all other audio channels are not muted. In some multimedia presentations, the center channel has much of the spoken audio and other channels include background noise, etc.; thus, muting only the center channel allows for muting of potentially offensive words, but maintains other audio. With a greater byte allocation, additional channels may be specifically muted. Alternatively, some bytes may be mapped to multiple channels. For example, in an audio system that includes multiple side channels, such as front right, middle right, and rear right, a single bit could designate all three channels.

Bytes 16-38 are related to the start time of the event, bytes 39-61 are related to the end time of the event, and the remaining bytes 62-63 involve padding. Referring first to byte 8, it is one byte in length and identifies the event action code (e.g., skip or mute). Bytes 9-15 are coded to identify the event classification for each possible combination of event classifications, such as is shown in Table 2. When the event filtering method, as discussed below, operates, a comparison is made between the filters activated by a particular user and the event classifications identified in bytes 9-14. Byte 15 is specified for audio channel mutes, which allows muting of one particular channel of an A/V presentation provided with multiple channels of audio, such as in a 5:1 format where only the center channel may be muted, where most discussion in a movie is presented, whereas other channels may not be muted.

The start time code and related time coding information is identified in bytes 16-38. Bytes 16-19 are reserved for the actual event start time code (HH:MM:SS:FF), byte 16 has hour information, byte 17 has minute information, byte 18 has second information, and byte 19 has frame information. Bytes 20-38 are reserved for identifying the start chapter number, start program chain number, start program unit number, start cell number, start address of VOBU N, start address of VOBU N+1, and frame number associated with the X frames offset from the beginning of VOBU N+1 associated with the start time for the filter event. Bytes 20-38 refer to various hierarchical information as defined in various DVD specifications. Bytes 39-61 are related to the end time code of a mute type filter, with bytes 39-42 allocated to the end time code designation (HH:MM:SS:FF), and bytes 43-61 allocated to hierarchical information for a particular VOBU associated with a particular frame where muting will be turned off. It is possible to mute with either the start and end time codes, or additionally with the hierarchical information

Aspects of the present invention further involve an indexing apparatus and method for identifying the multimedia presentations available on a particular memory media containing a plurality of filter tables. In order to provide convenient access to filter tables for many possible multimedia presentations, a particular memory media may contain hundreds or thousands of filter tables.

In one implementation, a unique identifier is generated for each multimedia presentation in which filter files have been developed, or in which there is information concerning whether a filter file (table) will or will not be developed. The unique identifier is generated as a function of the file size of the multimedia presentation. Unique identifiers may be generated based on each DVD, or each side of each DVD, when a DVD has multiple sides.

Each memory media having a plurality of filter tables (i.e., collection of filter files for a particular multimedia presentation) includes a master index with a listing of the total number of unique identifiers available on the filter disc. For each unique identifier there is a separate table providing a pointer within the multimedia to the specific filter table for that identifier (if its present) along with additional information concerning the filter table, including whether or not the filter table is actually on the memory media, whether a filter table will be generated, and the MPAA rating value for the title.

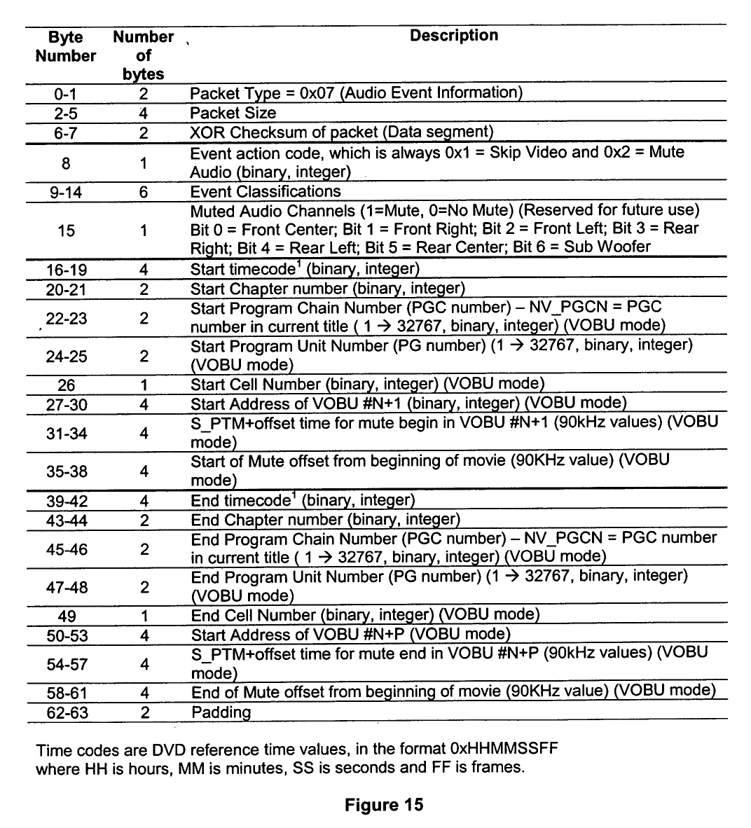

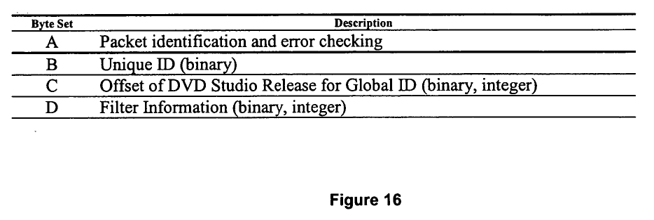

FIG. 16 is the file format for an individual unique identifier record for a particular filter disc. A filter disc comprises of a collection of filter tables. Byte set A are packet identification and error checking bytes. Byte set B contains the unique identifier for the particular table. Byte set C provides the pointer, within the disc, to the specific filter information for the unique identifier, including the formats of FIGS. 13 and 15. Byte set D provides particular filter information. Bit 0 indicates whether the filter is present on the disc (Bit 0=1, on disc; Bit 0=0, not on disc). By way of file format of FIG. 13, access to any particular filter file may be provided.

Access to any particular filter table may also be provided as a function of the title of the multimedia presentation of the filter, e.g., by searching for Gladiator, access to one or more Gladiator filter tables may be achieved. There is an identification of the total number of filter tables identified as a function of title. There is also a table for each title listing. Filter tables are stored alphabetically (A to Z) and in ascending numerical order (1-9) based on the title of the multimedia presentation associated with a particular filter table. The table includes a character identifier, such as alpha characters (e.g., A-Z), numeric characters (e.g., 0-9), and other characters (e.g., !, @, #, etc.). Thus, for each character (A, B . . . 0, 1 . . . !, @, etc.) there is a separate table. Further, each character table includes an identification of the number of filters for the character and a map to the first entry in the character table. From this table, the system may generate a character-based listing, such as an alphabetical listing of the filter available on the disc. Further, the listing may be accessible based on character entry. So, for example, a screen may be generated that includes an alphabetical listing, and by selecting any letter in the alphabet, the user may access a list of all filters available where the title of the multimedia presentation associated with that filter begins with the selected character.

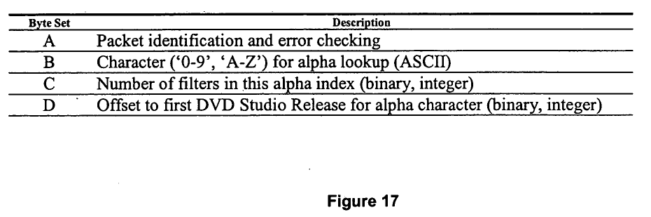

FIG. 17 is the file format for a character based look-up table. Byte set B includes the character identifier for a particular table. Byte set B provides ASCII information for each character. Thus, the table for character “A” will have the ASCII value for A provided in byte set B. Byte set C provides an identification of the total number of filter tables associated with the particular character. Finally, byte set D provide a pointer to the first filter table for the particular character. For example, for “A” the pointer will point to the first filter table for the first multimedia presentation title beginning with A, which may be arranged within the A set of filter tables in alphabetical order.

The filter tables on a particular memory media may further be indexed or identified based upon the time of release of the filter table. For example, all filter tables released within 90 days may be highlighted. When new filter table releases closely track new multimedia presentation releases (new movies released on DVD, for example), then a user may be able to quickly determine whether a filter table for the new DVD release has been generated by searching only new releases. There is a new release record (table) for each new release. Each new release table provides a pointer to the filter table information for the new release. Thus, a user may obtain a list of all filter tables for new releases only.

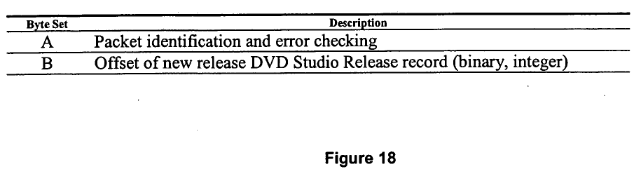

A particular filter table may be identified by one or more indexing tables, in various possible implementation conforming to aspects of the present invention. FIGS. 18-23 represent indexing tables, that used collectively provide a map into one or a set of filter tables for a particular multimedia presentation. The map provides flexibility to account for versions of filter tables, versions of a movie title, formatting variations for a multimedia presentation, filtering modes (e.g. time-based filtering and location based filtering), and other mapping efficiencies.

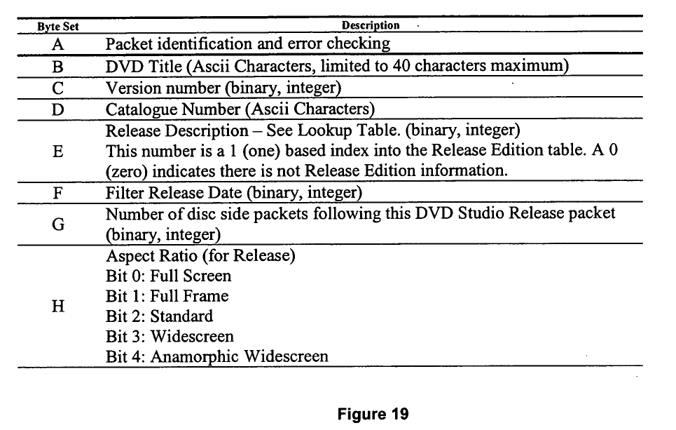

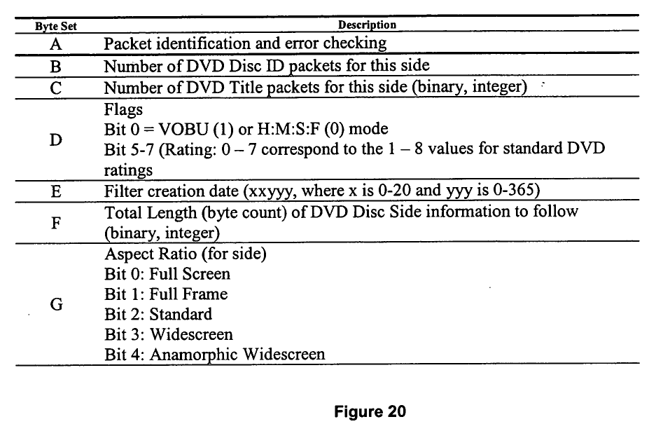

Referring first to FIG. 19, a studio release table is shown. The studio release table provides one or more bytes (byte set B), to identify the multimedia title (e.g., “Gladiator”) for the a particular filter table or set of filter tables. Byte set C includes the release number of the particular filter table. It is possible to have multiple releases of filter tales for a particular multimedia presentation. Byte set D provides and identifier of the studio catalog number for a particular version of a multimedia title. Some movies, for example, may have an unrated version, directors cut, extended play versions, etc. Each of which may have a unique catalogue number. Bytes set E provides similar release edition information, but in the form of an alphanumeric descriptor (e.g., “Director's Cut”) as opposed to a catalogue number. Byte set F provides the release date for the filter table. Byte set G provides a map to tables established for multi-sided releases (see discussion of FIG. 20 below). Byte set H provides aspect ratio information for the particular multimedia presentation associate with a particular filter file.

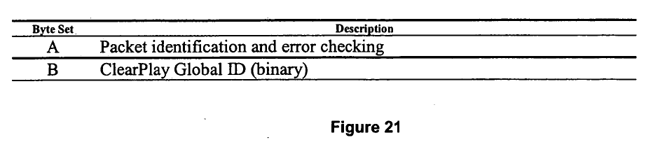

Some multimedia titles may be associated with a plurality of physical disc sides. For example, some DVD movies, may be provided on both sides of a DVD, or a plurality of sides of a DVD. If byte set G of FIG. 19 is 1, then the values for this table are not defined and the movie is on a single disc side. If Byte set G of FIG. 19 is 2 or more, then there are 2 or more disc side table, respectively. Referring to FIG. 20. byte set B is discussed in detail below with regard to FIG. 21. Byte set C indicates the number of DVD title packets for the disc side represented by the table. In most instances, this value will be 1 representing the main movie title. However, it is possible to set up filter tables for other titles that may be on the same side of a disc. For example, the main movie title (e.g., Gladiator) may be provided with another DVD title, such as an interview with a director may also have a filter file. Byte set D identifies the type of filter identifier applied in the filter file. As discussed above, time code based filtering an location based filtering (as a function of VOBU) may be defined in a particular filter, in various implementations of the present invention. As such, bytes set D defines one or the filtering identifier types. Byte set D also provides the MPAA rating for the particular DVD title. MPAA ratings are typically applied on a movie basis. In this instance, MPAA ratings may be identified on a DVD title basis. Byte set F provides the filter creation date. Byte set G provides information concerning the total byte length for all filter specific mapping files for the particular filter table. Byte set H provides the aspect ratio for the particular DVD side.

The table shown in FIG. 21 provides a second unique identifier for the particular side of the DVD. This unique identifier also accounts for any changes in the unique identifier that may occur if a different length version of a multimedia presentation is released.

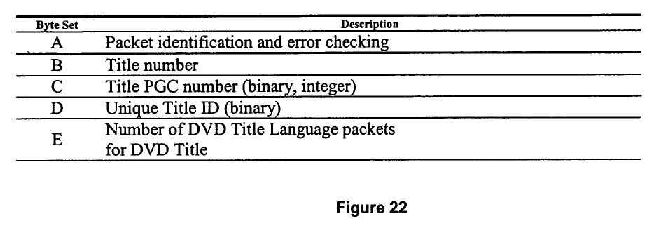

The table shown in FIG. 22 is provided when separate titles on a particular side of a DVD have unique filters. There is a separate table for each filtered title. Byte set B identifies the title. Byte set C identifies the program chain number of the title. Byte set D indicates a unique identifier for the particular title. With such a unique identifier, it is possible to search globally for various possible filters (e.g., search for a filter for “Gladiator”) or to search for filters for various titles within a DVD disc side. Bytes set E identifiers the number of different language versions that filters are available. For example, objectionable language may be different based on a particular language; thus, filtering based on objectionable language may also be different based upon the language available. Byte set E provides a map to the number of language table, for which there is a separate table for each supported language.

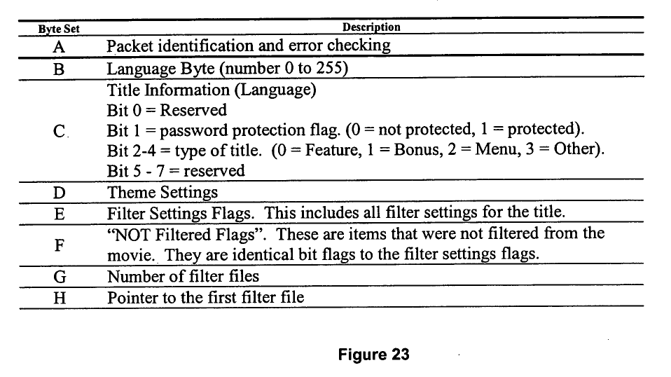

The table of FIG. 23 provides the actual pointer to the specific filter file information for the multimedia presentation. Depending on the particular multimedia presentation, the pointer may address the filter files as a function of the film title, the disc side, the DVD title, language, and other factors addressed above. Byte set G indicates the number of filter files in a particular filter table. Byte set H is the pointer to the first filter file for the multimedia presentation.

The table of FIG. 23 also provides other information. First, bytes set B provides a language identifier for the filter file. Byte set C provides title information as shown in the diagram. Byte set D is pointer into theme descriptors for the multimedia presentation. The theme descriptors do not provide filtering, but rather provide a textual description of various thematic topics presented in a particular multimedia presentation. For example, where a suicide occurs in a particular movie, the theme “suicide” may be presented to the user as a function of the thematic descriptor. As such, if the user has activated filtering, before playback begins, the thematic descriptor or descriptors will be presented to the user on the display. With such information, a parent may be better informed about a particular movie and make more informed decisions concerning whether to let children view the movie. Thematic descriptors provide more detailed information than conventional MPAA rating schemes. Byte set E provides an identification of the particular filter types available for the multimedia presentation, and byte set F provides an indication of the filter types not available. Byte set G identifies the total number of activatable filter files for the multimedia presentation.

Aspects of the present invention extend to methods, systems, and computer program products for automatically identifying and filtering portions of multimedia content (such as a multimedia presentation provided in a DVD format). The embodiments of the present invention may comprise a DVD player, a special purpose or general purpose computer including various computer hardware, a television system, an audio system, and/or combinations of the foregoing. These embodiments are discussed in detail above. However, in all cases, the described embodiments should be viewed a exemplary of the present invention rather than as limiting it's scope.

Embodiments within the scope of the present invention also include computer-readable media for carrying or having computer-executable instructions or data structures stored thereon. Such computer-readable media may be any available media that can be accessed by a general purpose or special purpose computer. By way of example, and not limitation, such computer-readable media can comprise RAM, ROM, EEPROM, CD-ROM, DVD, or other optical disk storage, magnetic disk storage or other magnetic storage devices, or any other medium which can be used to carry or store desired program code means in the form of computer-executable instructions or data structures and which can be accessed by a general purpose or special purpose computer. Implementations of the present invention may be stored as computer readable instructions on a DVD along with a multimedia presentation intended to be filtered and played back with various time sequences muted or skipped. When information is transferred or provided over a network or another communications link or connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer executable instructions comprise, for example, instructions and data which cause a DVD player, a general purpose computer, special purpose computer, or special purpose processing device to perform a certain function or group of functions.

Although not required, aspects of the invention may be deployed as computer-executable instructions, such as program modules, being executed by a DVD player. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps. Furthermore, program code means being executed by a processing unit provides one example of a processor means.

We claim:

1. A method of filtering portions of a multimedia content presentation, the method comprising:
accessing at least one filter file defining a filter start indicator and a filter action;
reading digital multimedia information from a memory media, the multimedia information including a location reference;
comparing the location reference of the multimedia information with the filter start indicator; and
responsive to the comparing operation, executing a filtering action if there is match between the location reference of the multimedia information and the filter start indicator of the at least one filterable portion of the multimedia content.

2. The method of claim 1 wherein the filter start indicator comprises a filter start time reference.

3. The method of claim 1 wherein the filter start time reference is the form of Hour:Minute:Second:Frame.

4. The method of claim 1 wherein the filter start time indicator comprises a memory location identifier.

5. The method of claim 4 wherein the memory location identifier includes a memory sector identifier.

6. The method of claim 1 wherein the start time reference includes a logical block number associated with a video object unit.

7. The method of claim 1 wherein the at least one filter file includes a content identifier.

8. The method of claim 7 wherein the at least one content identifier is selected from the group comprising violence, sex and nudity, language, and other.

9. The method of claim 1 wherein the digital multimedia information comprises encoded video and audio data.

10. The method of claim 9 wherein the multimedia content information comprises motion pictures expert group (MPEG) encoded video and audio data.

11. The method of claim 9 further comprising decoding the encoded video and audio data.

12. The method of claim 11 further comprising the operation of playing the decoded video and audio data.

13. The method of claim 9 further comprising, prior to decoding the multimedia information, comparing the location reference of the multimedia information with the filter start indicator.

14. The method of claim 1 further comprising the operation of storing the digital multimedia information in a buffer memory.

15. The method of claim 14 further comprising the operation of comparing the location reference of the multimedia information in the buffer memory with the filter start indicator

16. The method of claim 1 wherein the memory media comprises an optical memory disc.

17. The method of claim 16 wherein the optical memory disc is a DVD.

18. The method of claim 1 wherein the operation of executing a filtering action comprises deleting the multimedia information in the memory buffer.

19. The method of claim 18 wherein the operation of executing a filtering action comprises deleting the multimedia information in the memory buffer irrespective of whether the buffer contains some multimedia information not being filtered.

20. The method of claim 1 wherein the filter file further comprises a filter end indicator.

21. The method of claim 19 wherein the operation of executing a filtering action comprises the operation of causing the reading of digital multimedia information from a memory media operation to advance to the filter end indicator.

22. The method of claim 21 wherein the filter end indicator comprises a filter end time reference.

23. The method of claim 22 wherein the filter end time reference is the form of Hour:Minute:Second: Frame.

24. The method of claim 22 wherein the filter end indicator comprises a memory location identifier.

25. The method of claim 24 wherein the memory location identifier includes a memory sector identifier.

26. The method of claim 21 wherein the filter end indicator comprises a logical block number associated with a video object unit.

27. A multimedia player configured to perform the operations of claim 1.
